(19) United States
(12) Patent Application Publication
(10) Pub. No.: US 2026/0008037 A1
(43) Pub. Date: Jan. 8, 2026

(54) RUTHENIUM CATALYSTS AND METHODS THEREOF

(71) Applicant: The Regents of the University of California, Oakland, CA (US)

(72) Inventors: Matthew Conley, Riverside, CA (US); Jessica Rodriguez, Roseville, CA (US); Joshua Richardson, Colton, CA (US)

(73) Assignee: The Regents of the University of California, Oakland, CA (US)

(21) Appl. No.: 18/992,391

(22) PCT Filed: Jul. 12, 2023
(86) PCT No.: PCT/US2023/027536

§ 371 Date: Jan. 8, 2025

Related U.S. Application Data
(60) Provisional application No. 63/388,571, filed on Jul. 12, 2022.

(51) Int. Cl. B01J 31/22; B01J 31/16; B01J 31/24; C07F 15/00

(52) U.S. Cl. CPC B01J 31/2226; B01J 31/1633; B01J 31/1666; B01J 31/2273; B01J 31/2404; C07F 15/0046; B01J 2231/543; B01J 2531/31; B01J 2531/821; B01J 2540/225

(57) ABSTRACT

Certain embodiments of the invention provide a supported cationic Ru catalyst that is highly active in catalyzing olefin metathesis. Certain embodiments of the invention also provide a method of making a supported cationic Ru catalyst described herein, comprising contacting a Ru catalyst with a silylium-capped support.

### CROSS REFERENCE TO RELATED APPLICATION

This application claims priority to U.S. Provisional Application No. 63/388,571 filed on 12 Jul. 2022. The entire content of the application referenced above is hereby incorporated by reference herein.

### GOVERNMENT FUNDING

This invention was made with government support under 2101582 awarded by the National Science Foundation. The government has certain rights in the invention.

### BACKGROUND OF THE INVENTION

The olefin metathesis reaction was discovered in studies of heterogeneous catalysts containing tungsten, molybdenum, or rhenium oxides supported on silica or alumina. A common route to generate a well-defined organometallic on a surface involves protonolysis of an M-X group (X=alkyl, amido, alkoxide, etc.) by an —OH group on the oxide (usually SiO₂) surface. Other strategies to heterogenize ruthenium catalysts onto oxides involve further derivatization followed by reaction with an oxide, or multi-step syntheses to access materials containing reactive groups that bind ruthenium compounds to form well-defined ruthenium catalyst. New ruthenium catalyst and efficient preparation methods are needed.

### SUMMARY OF THE INVENTION

Certain embodiments of the invention provide a method for catalyzing olefin metathesis, comprising contacting one or more reactant olefin with a catalyst composition described herein.

Certain embodiments of the invention provide a catalyst composition, comprising a cationic Ruthenium (Ru) catalyst and a support. The cationic Ru catalyst has structure of Formula I

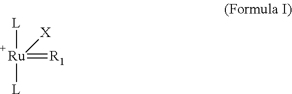

wherein
   X is absent, halogen, O(O═)CRₜ or —ORₓ, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is O(O═)CRₜ, the one (the non-carbonyl oxygen) or two oxygen(s) of O(O═)CRₜ is bonded with the Ru;
   R₁ is aryl (e.g., indenylidene) or (CH)-aryl (e.g., benzylidene), wherein the aryl or (CH)-aryl is optionally substituted with one or more substituent selected from the group consisting of hydroxy, halogen, alkyl, alkoxy, nitro (—NO₂), or aryl; and
   each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl (e.g., mesityl), and wherein Rₐ is alkyl, cycloalkyl, or aryl that is optionally substituted with one or more alkyl; wherein one L is absent when X is O(O═)CRₜ and the two oxygen(s) of O(O═)CRₜ are bonded with the Ru;
   wherein when X is absent, one L (a bidentate ligand when X is absent) is heterocycle, or heteroaryl substituted with one or more substituent (e.g., alkyl or adamantyl) and the substituent forms a Ru—C bond with the Ru;
   wherein Ru, together with the intervening carbon atoms of R₁, and the oxygen atom of —O— or alkoxy of one L, optionally form a ring (e.g., a five-membered ring);
   and a support.

Certain embodiments of the invention provide a method of making a catalyst composition described herein, comprising contacting a Ru compound of Formula II with a silylium on a support,
wherein the silylium has structure of ⁺Si(Rₘ)₃, wherein Rₘ is alkyl or aryl, and the aryl is optionally substituted with one or more alkyl; and
the Ru compound of Formula II is

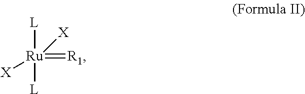

each X is independently halogen, O(O═)CR; or —ORₓ, one X may be absent, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is —O(O═)CRₜ, the one oxygen of —O(O═)CRₜ is bonded with the Ru, or only one X is O(O═)CRₜ wherein the two oxygens of O(O═)CRₜ are bonded with the Ru;
R₁ is aryl (e.g., indenylidene) or (CH)-aryl (e.g., benzylidene), wherein the aryl or (CH)-aryl is optionally substituted with one or more substituent selected from the group consisting of hydroxy, halogen, alkyl, alkoxy, nitro (—NO₂), or aryl; and each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl (e.g., mesityl), and wherein Rₐ is alkyl, cycloalkyl, or aryl that is optionally substituted with one or more alkyl; wherein one L is absent when only one X is O(O═)CRₜ and the two oxygen(s) of O(O═)CRₜ are bonded with the Ru;
   wherein when one X is absent, one L (a bidentate ligand when X is absent) is heterocycle, or heteroaryl substituted with one or more substituent (e.g., alkyl or adamantyl) and the substituent forms a Ru—C bond with the Ru;
   wherein Ru, together with the intervening carbon atoms of R₁, and the oxygen atom of —O— or alkoxy of one L, optionally form a ring (e.g., a five-membered ring).

Certain embodiments of the invention provide a heterogeneous ruthenium catalyst as described herein.

Certain embodiments of the invention provide a heterogeneous cationic ruthenium catalyst as described herein.

Certain embodiments of the invention provide a method as described herein for making a heterogeneous ruthenium catalyst as described herein.

Certain embodiments of the invention provide a method as described herein for making a heterogeneous cationic ruthenium catalyst as described herein.

Certain embodiments of the invention provide a catalyst system comprising an activated heterogeneous ruthenium catalyst (active for catalyzing olefin metathesis) as described herein.

Certain embodiments of the invention provide a catalyst system comprising an activated heterogeneous cationic ruthenium catalyst as described herein.

Certain embodiments of the invention provide an olefin metathesis method comprising, coupling two olefins using an activated heterogeneous ruthenium catalyst as described herein.

Certain embodiments of the invention provide an olefin metathesis method comprising, coupling two olefins using an activated heterogeneous cationic ruthenium catalyst as described herein. In certain embodiments, the two olefins have different structures. In certain embodiments, the two olefins have the same structure, thus, two identical reactant olefins are coupled to form a product olefin.

Certain embodiments of the invention provide a compound described herein.

Certain embodiments of the invention provide a composition described herein.

Certain embodiments of the invention provide a catalyst compound or composition described herein (e.g., for use in catalyzing olefin metathesis).

Certain embodiments of the invention provide a supported catalyst described herein.

Certain embodiments of the invention provide a mixture described herein.

Certain embodiments of the invention provide a method described herein.

Certain embodiments of the invention provide a compound or composition described herein.

The invention also provides processes and intermediates disclosed herein that are useful for preparing a compound or catalyst described herein.

### BRIEF DESCRIPTION OF THE FIGURES

FIG. 1. Generation of well-defined heterogeneous d⁰ catalysts for olefin metathesis.

FIGS. 2A-2B. Selected heterogeneous Ru catalysts (FIG. 2A) and an exemplary cationic catalyst (1) described herein (FIG. 2B), R^{F} is C(CF₃)₃.

FIG. 3. Stacked spectrum for quantification of TIPSCl that comes off during reaction.

FIG. 4. Quantification of GH2 that comes off during reaction.

FIG. 5. Quantification of GH2 that comes off during reaction.

FIG. 6. FTIR spectrum of 1.

FIG. 7. 13C{1H} HP-DEC MAS NMR spectrum of 1 spinning at 10 kHz.

FIG. 8. 1H NMR spectrum of 1 spinning at 10 kHz.

FIG. 9. Stacked GC-FID of the reaction at 3, 30, and 120 min (4.2, 54.8, and 85.5% conversions).

FIG. 10. Conversion of 1-decene versus time.

FIG. 11. GC-FID graph of E/Z decene conversion with supported catalyst.

FIG. 12.1H NMR of the olefin region immediately (bottom) and 5 days after (top) preparation of the sample.

FIG. 13. Bar graph for conversion of 1-decene (829,000 TON).

FIG. 14. GC-FID of 1-decene metathesis reaction (Max TON).

FIG. 15. Stacked GC-FID of the reaction at 3, 30, and 240 min (16.4, 29.2, and 32.7% conversions).

FIG. 16. Conversion of allyltrimethylsilane versus time.

FIG. 17. ¹H NMR of the olefin region after reaction is stopped; 1:2.3 (E:Z).

FIG. 18. Stacked GC-FID of the reaction at 3, 30, and 240 min (11.4, 42.1, and 65.3% conversions).

FIG. 19. Conversion of allylbenzene versus time.

FIG. 20. Allylbenzene metathesis conversion E/Z percentage.

FIG. 21. Stacked GC-FID of the reaction at 5, 30, and 360 min (0.6, 7.2, and 14.2% conversions).

FIG. 22. Conversion of methyl acrylate versus time.

FIG. 23. ¹H NMR of the olefin region of the isolated product after the reaction was stopped at 24 hours.

FIG. 24. NMR of ring-closing metathesis (RCM) reaction with supported catalyst.

FIG. 25. GC-FID of RCM reaction with supported catalyst.

FIG. 26. GC-FID for graph of cross metathesis reaction with the supported catalyst.

FIG. 27. Cross metathesis reaction with the supported catalyst.

FIG. 28. GC-FID for ethenolysis reaction for the supported catalyst.

FIG. 29. Exemplary catalyst of Grubb's-II on TMS SZO.

FIG. 30. Catalytic Test of an exemplary catalyst: 0.2 mol % G-II. TOF=initial turnover frequency (per minute)=[mol product]/[mol Ru][time]. TON=turnover number at max conversion=[mol product][mol Ru].

FIG. 31. Catalytic Test of an exemplary catalyst: 0.1 mol % G-II.

FIG. 32. Catalytic Test of an exemplary catalyst: 0.05 mol % G-II.

FIG. 33. Catalytic Test of an exemplary catalyst: 0.01 mol % G-II.

FIG. 34. Catalytic Test of an exemplary catalyst: 0.005 mol % G-II.

FIG. 35. An exemplary catalyst of Grubb's-II on TIPS-ASO. 0.19 mmol/g free TIPSCl was produced if fresh TIPS ASO is used (0.068 mmol/g free TIPSCl was produced if old TIPS ASO is used (made about a week prior)).

FIG. 36. Catalytic Test of catalyst on supports: 0.01 mol % G-II.

FIG. 37. An exemplary catalyst of Grubb's-II on TIPS-ASO. 0.211 mmol/g free TIPSCl was produced.

FIG. 38. Catalytic Test of an exemplary catalyst: 1 mol % Ru-2.

FIG. 39. Catalytic Test of an exemplary catalyst: 0.01 mol % Ru-2.

FIG. 40. Catalytic Test of an exemplary catalyst: 0.01 mol % GH-II.

FIG. 41. Catalytic Test of an exemplary catalyst: 0.001 mol % Ru-2.

FIG. 42. Catalytic Test of a catalyst: 0.001 mol % Ru-2 (homogenous).

FIG. 43. Max TON experiment. Cross metathesis of with ethylene competes with homometathesis (45.4% decene after 35 days; at least 720K turnovers).

FIG. 44. 1-Decene metathesis. Typical GC of high TON experiment; all metathesis products. Low TON experiment leads to less cross-metathesis.

FIG. 45. Allyltrimethylsilane metathesis reaction nearly done at 1 hour; major product is the homocoupled product other minor product are unidentified (solvent at 2.4 min).

FIG. 46. 1-Decene metathesis.

FIG. 47. Certain exemplary Ruthenium compounds.

FIG. 48. Certain exemplary Ruthenium catalysts (e.g., cationic Ru catalysts).

### DETAILED DESCRIPTION

Certain embodiments of the invention provide a Ru catalyst and methods of making the catalyst described herein. In one embodiment, the invention can be prepared using silylium capped surfaces. For example, the first is a silylium capped sulfated zirconia. The second is a Lewis acid functionalized silica containing silylium (e.g., a silylium capped silica-aluminum alkoxide, also see Example 1). These silylium capped surfaces abstract halide ions from commercially available ruthenium catalysts (e.g., 2nd generation Grubbs-Hoveyda (GH-II) catalyst) to form ion-pairs. The cationic ruthenium catalysts are very active in olefin metathesis reactions. Data shown herein suggests that these cationic heterogeneous catalysts are at least twice as active as neutral homogeneous catalysts in solution. As described herein (e.g., see Example 1), the catalyst composition comprises supported cationic Ru catalyst via formation of ion-pairs. In certain embodiments, the catalyst composition does not comprise Ru catalyst that is bound to the support via covalent bond.

Accordingly, certain embodiments of the invention provide a catalyst composition, comprising a cationic Ruthenium (Ru) catalyst and a support. The cationic Ru catalyst has structure of Formula I:

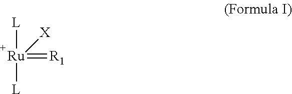

wherein
   X is absent, halogen, O(O═)CRₜ or —ORₓ, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is O(O═)CRₜ, the one or two oxygen(s) of O(O═)CRₜ is bonded with the Ru;
   R₁ (an alkylidene ligand for Ru) is aryl (e.g., indenylidene) or (CH)-aryl (e.g., benzylidene (═CHPh)), wherein the aryl or (CH)-aryl is optionally substituted with one or more substituent selected from the group consisting of hydroxy, halogen, alkyl (e.g., C1-C6 alkyl), alkoxy (e.g., C1-C6 alkoxy), nitro (—NO₂), or aryl; and
   each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl, and wherein Rₐ is alkyl, cycloalkyl, or aryl that is optionally substituted with one or more alkyl; wherein one L is absent when X is O(O═)CRₜ and the two oxygen(s) of O(O═)CRₜ are bonded with the Ru;
   wherein when X is absent, one L (a bidentate ligand when X is absent) is heterocycle, or heteroaryl substituted with one or more substituent (e.g., alkyl or adamantyl) and the substituent forms a Ru—C bond with the Ru;
   wherein Ru, together with the intervening carbon atoms of R₁, and the oxygen atom of —O— or alkoxy of one L, optionally form a ring (e.g., a five-membered ring).

In certain embodiments, X is Cl, Br, or I.

In certain embodiments, X is Cl.

In certain embodiments, X is —ORₓ, wherein Rₓ is alkyl, alkanoyl, or aryl, and the alkyl, alkanoyl, or aryl is optionally substituted with one or more substituent of hydroxy or halogen (e.g., F). In certain embodiments, Rₓ is alkanoyl (e.g., acetyl).

In certain embodiments, X is absent, and one L (a bidentate ligand when X is absent) is heterocycle, or heteroaryl substituted with one or more substituent (e.g., alkyl or adamantyl) and the substituent forms a Ru—C bond with the Ru.

In certain embodiments, X is O(O═)CRₜ, wherein Rₜ is alkyl or aryl and the alkyl, or aryl is optionally substituted with one or more substituent of hydroxy or halogen (e.g., F).

In certain embodiments, X is —O(O═)CRₜ, wherein one oxygen (i.e., the non-carbonyl oxygen) of the X forms a Ru—O bond with the Ru and the cationic Ru catalyst has structure of

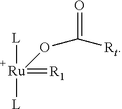

In certain embodiments, X is O(O═)CRₜ, wherein the two oxygen atoms are bonded with the Ru and the cationic Ru catalyst has structure of

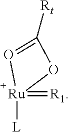

In certain embodiments, X is halogen or —ORₓ.

In certain embodiments, X is O(O═)CRₜ or —ORₓ.

In certain embodiments, Rₜ is alkyl (e.g., C1-C6 alkyl, such as methyl or t-butyl). In certain embodiments, Rₜ is aryl.

In certain embodiments, R₁ is aryl or (CH)-aryl, wherein the aryl or (CH)-aryl is optionally substituted on the aryl ring with substituent Y, which is selected from the group consisting of hydroxy, halogen, alkyl, alkoxy, nitro (—NO₂), or aryl.

In certain embodiments, R₁ is aryl optionally substituted with one or more substituent selected from the group consisting of hydroxy, halogen, alkyl, alkoxy, nitro (—NO₂), or aryl.

In certain embodiments, R₁ is indenylidene.

In certain embodiments, R₁ is indenylidene substituted with phenyl. In certain embodiments, R₁ has structure of

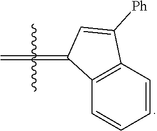 [SMILES: *=C1C=C(c2ccccc2)c2ccccc21]

In certain embodiments, R₁ is (CH)-aryl optionally substituted with one or more substituent selected from the group consisting of hydroxy, halogen, alkyl, alkoxy, nitro (—NO₂), or aryl.

In certain embodiments, R₁ is benzylidene (═CHPh), optionally substituted with one or more substituent selected from the group consisting of hydroxy, halogen, alkyl, alkoxy, nitro (—NO₂), or aryl.

In certain embodiments, R₁ is benzylidene (═CHPh).

In certain embodiments, R₁ is p-nitrobenzylidene.

In certain embodiments, the cationic Ru catalyst has structure of Formula Ia:

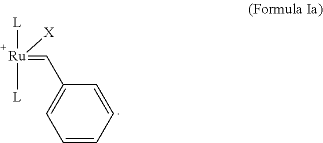

In certain embodiments, the cationic Ru catalyst has structure of Formula Ib:

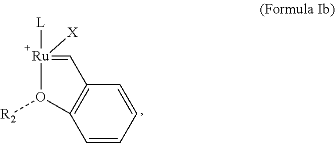

wherein R₂ is alkyl (e.g., C1-C6 or C1-C4 alkyl, such as isopropyl). For example, in certain embodiments, the cationic Ru catalyst has structure of

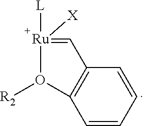

In certain embodiments, R₂ is isopropyl.

In certain embodiments, the cationic Ruthenium catalyst has structure of

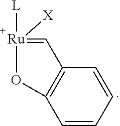

In certain embodiments, the cationic Ru catalyst has structure of Formula Ic:

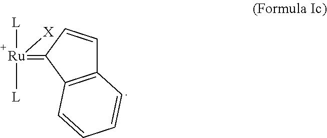

In certain embodiments, one or two L is P(Rₐ)₃, wherein Rₐ is alkyl (e.g., C1-C6 alkyl), cycloalkyl (e.g., C4-C6 cycloalkyl), or aryl.

In certain embodiments, Rₐ is cycloalkyl. In certain embodiments, P(Rₐ)₃ is tricyclohexylphosphine (PCy₃).

In certain embodiments, one or two L is P(Rₐ)₃, wherein Rₐ is alkyl, or aryl that is optionally substituted with one or more alkyl (e.g., C1-C6 alkyl). In certain embodiments, P(Rₐ)₃ is trimethylphosphine, or tri-t-butylphosphine. In certain embodiments, P(Rₐ)₃ is triphenylphosphine, or tri(o-tolyl)phosphine.

In certain embodiments, one or two L is optionally substituted heteroaryl. In certain embodiments, one or two L is pyridine.

In certain embodiments, one L is —O— or alkoxy (e.g., C1-C6 alkoxy), wherein the oxygen of —O— or alkoxy, together with the intervening carbon atoms of R₁ (e.g., —CHPh), and Ru form a ring (e.g., 5 membered ring). In certain embodiments, the alkoxy is O-isopropyl.

In certain embodiments, one or two L is optionally substituted heterocycle. In certain embodiments, one or two L is 2-imidazolidinyl. In certain embodiments, one or two L is 1,3-dimesityl-2-imidazolidinyl. In certain embodiments, one or two L is optionally substituted 2-pyrrolidinyl. In certain embodiments, one or two L is optionally substituted 5,5-dimethyl-2-pyrrolidinyl.

In certain embodiments, each L is independently selected from the group consisting of —O—, alkoxy, P(Rₐ)₃,

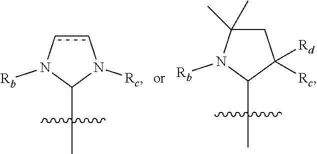

wherein R_{b}, R_{c}, R_{d} is independently H, alkyl, adamantyl, or aryl; and the aryl is optionally substituted with one or more alkyl. For example, in certain embodiments, one or two L is

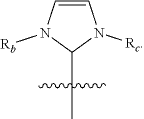

In certain embodiments, one or two L is

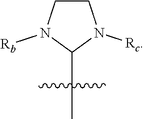

In certain embodiments, R_{b} and Re are the same group. In certain embodiments, R_{b} and R_{c} are each phenyl. In certain embodiments, R_{b} and R_{c} are each independently phenyl optionally substituted with one or more alkyl. In certain embodiments, R_{b} and R^{e} are each mesityl (Mes).

In certain embodiments, R_{b} and R_{c} are not the same group.

In certain embodiments, each L is independently —O—, alkoxy, P(Rₐ)₃, or heterocycle.

In certain embodiments, each L is independently P(Rₐ)₃, or heterocycle.

In certain embodiments, each L is independently —O—, alkoxy, or P(Rₐ)₃.

In certain embodiments, each L is independently —O—, alkoxy, or heterocycle.

In certain embodiments, the cationic Ru catalyst has structure of Formula Id:

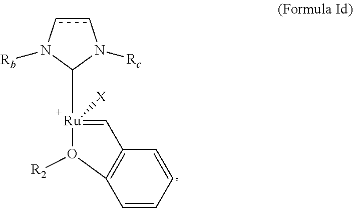

wherein R₂ is alkyl (e.g., C1-C6 alkyl). In certain embodiments, R₂ is isopropyl.

In certain embodiments, X is absent, and a substituent on one L (wherein L is heterocycle or heteroaryl) also forms a Ru—C bond. For example, in certain embodiments, one of R_{b} and R_{c} forms a Ru—C bond. Accordingly, in certain embodiments, the cationic Ru catalyst has structure of Formula Ie:

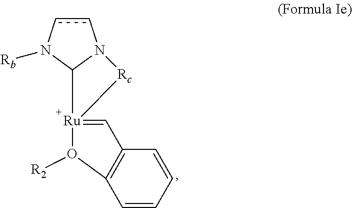

wherein R₂ is alkyl (e.g., C1-C6 alkyl). In certain embodiments, R₂ is isopropyl.

In certain embodiments, R_{c} is adamantyl or alkyl. In certain embodiments, R_{c} is adamantyl. In certain embodiments, R_{c} is adamantyl and R_{b} is optionally substituted aryl.

In certain embodiments, the cationic Ru catalyst has structure of

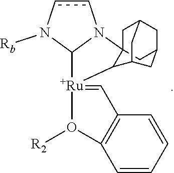

Accordingly, in one embodiment, the invention provides the following exemplary cationic ruthenium catalysts that can be used in the methods of the invention. Thus, in certain embodiments, the cationic Ru catalyst has a structure of:

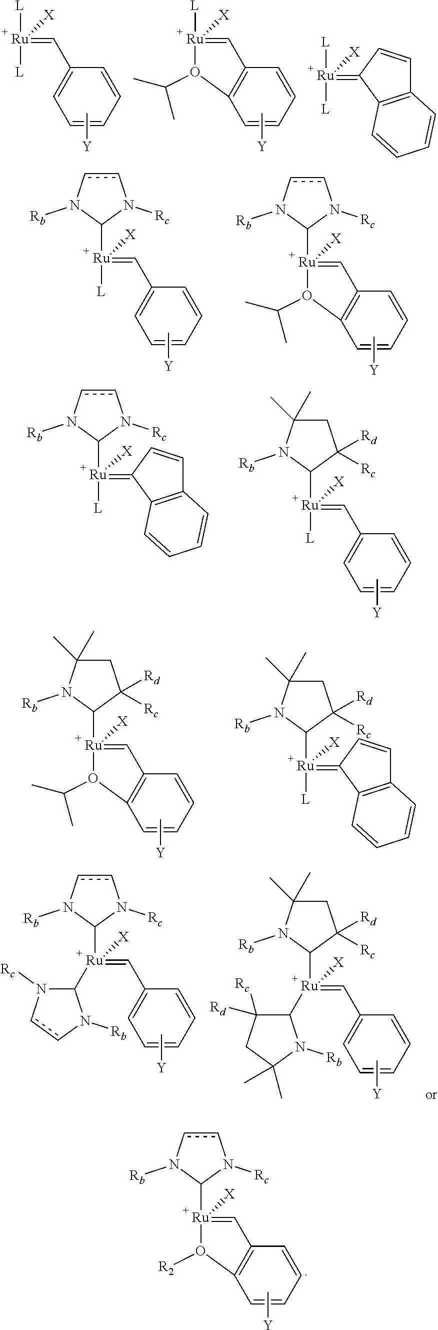

In certain embodiments, the cationic Ru catalyst has structure of

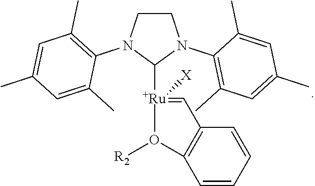

In certain embodiments, the cationic Ruthenium catalyst has structure of

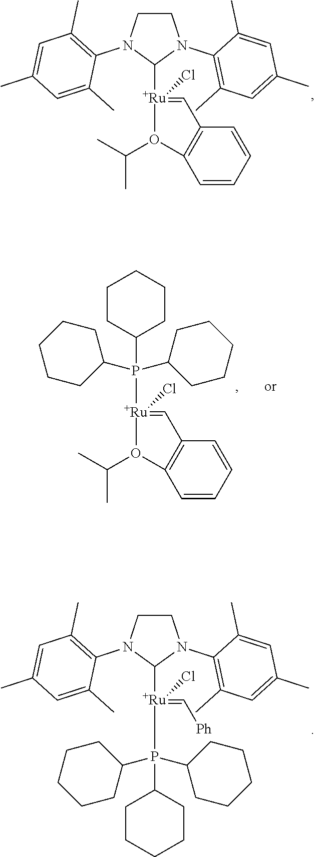

In certain embodiments, the cationic Ruthenium catalyst has structure of

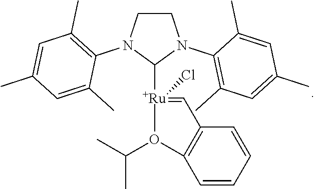

The support is an anionic solid support that provides negatively charged surface to support the cationic Ru catalyst. Accordingly, the cationic Ru catalyst could form ion-pairs with the anionic group on the support surface (e.g., anionic metal and/or non-metal oxide surface).

In certain embodiments, the support comprises metal and/or non-metal oxides. In certain embodiments, the support comprises SiO₂/Al₂O₃.

In certain embodiments, the support comprises metal oxide (e.g., Al₂O₃, ZrO₂, TiO₂, or CeO₂). In certain embodiments, the support comprises sulfated metal oxide, for example, sulfated zirconia (sulfated ZrO₂), sulfated TiO₂, or sulfated CeO₂.

In certain embodiments, the support comprises non-metal oxide, for example, silica (SiO₂). In certain embodiments, the support comprises oxide EₓO_{y}, wherein E is metal or non-metal; x is 1 or 2; and y is 2 or 3. For example, in certain embodiments, the support comprises oxide EₓO_{y}, wherein E is Si, Al, Zr, Ti, or Ce; x is 1 or 2; and y is 2 or 3. The oxide EₓO_{y} surface may comprise-OH group. In certain embodiments, the support comprises oxide-Aluminum alkoxide (EₓO_{y}/Al(OR^{s})₃) having structure of

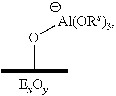

wherein R^{s} is alkyl (e.g., C1-C6 or C1-C4 alkyl such as t-butyl) optionally substituted with one or more halogen (e.g., F).

In certain embodiments, the support comprises silica-Aluminum alkoxide (SiO₂/Al(OR^{s})₃), wherein R^{s} is alkyl (e.g., C1-C6 or C1-C4 alkyl such as t-butyl) optionally substituted with one or more halogen (e.g., F).

In certain embodiments, R^{s} is perfluoro alkyl (e.g., perfluoro t-butyl). In certain embodiments, R^{s} is C(CF₃)₃.

In certain embodiments, the silica-Aluminum alkoxide (SiO₂/Al(OR^{s})₃) has structure of

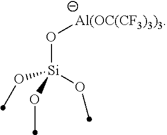

In certain embodiments, the catalyst composition comprises ion-pair of a cationic Ru catalyst described herein (e.g., Formula I, Ia, Ib, Ic, or Id), and an anionic support described herein (e.g., sulfated zirconium oxide (SZO), or silica-aluminum alkoxide). For example, in certain embodiments, the catalyst composition comprises ion-pair having structure of

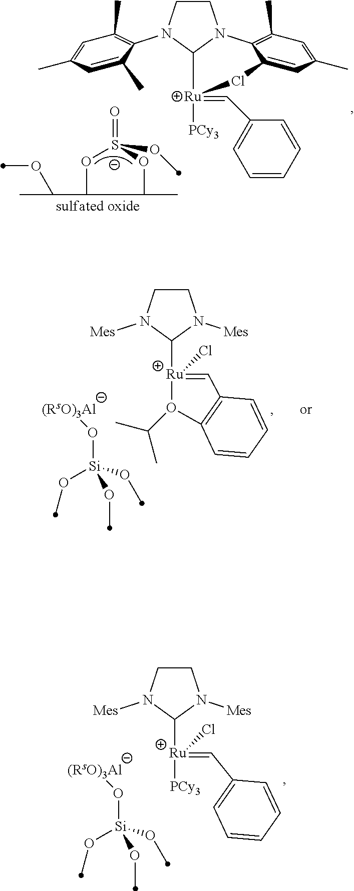

wherein R^{s} is alkyl (e.g., C1-C6 or C1-C4 alkyl such as t-butyl) optionally substituted with one or more halogen (e.g., F).

In certain embodiments, the catalyst composition comprises ion-pair having structure of

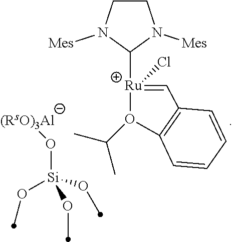

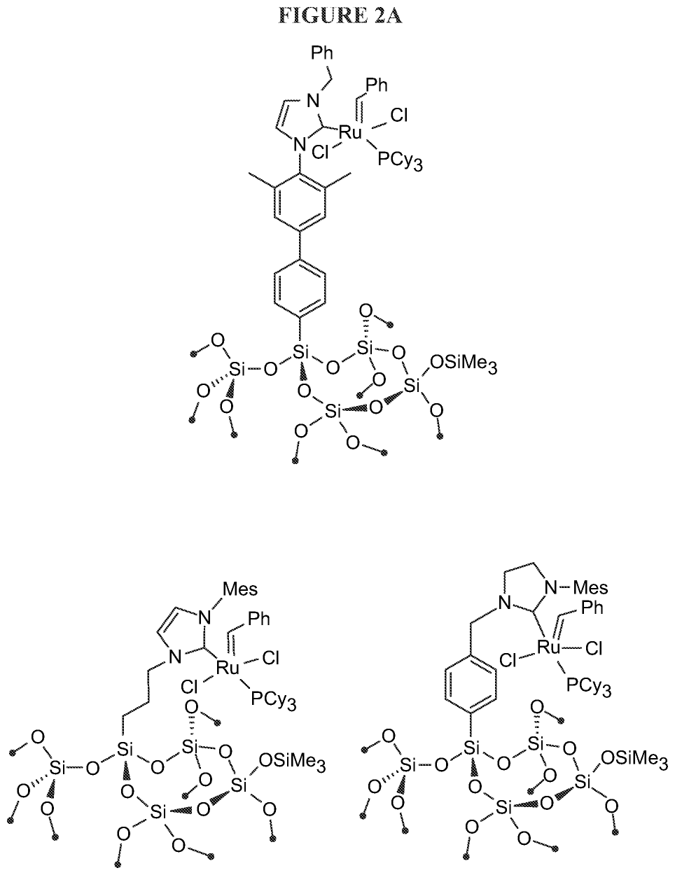

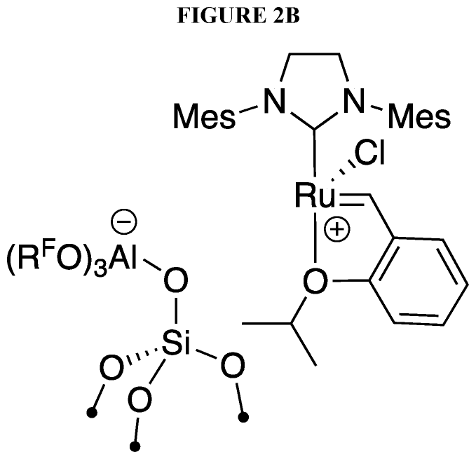

In certain embodiments, the catalyst composition comprises ion-pair [(IMes)Ru(═CH (o-OⁱPr—C₆H₄)Cl][(R^{s}O)₃Al—OSi≡)] (1) (also see Example 1 and FIG. 2B), wherein IMes is 1,3-dimesityl-2-imidazolidinyl, and R^{s} is C(CF₃)₃.

In certain embodiments, the catalyst composition comprises a mole percentage of the cationic Ru catalyst at about 0.001 to 1 mol %, 0.005 to 1 mol %, 0.01 to 1 mol %, 0.05 to 1 mol %, 0.1 to 1 mol %, 0.5 to 1 mol %, or 1 mol % to 5 mol %. In certain embodiments, the catalyst composition comprises a mole percentage of the cationic Ru catalyst at about 5, 1, 0.5, 0.1, 0.05, 0.01, 0.005, 0.001 mol % or lower. In certain embodiments, the catalyst composition comprises a mole percentage of the cationic Ru catalyst at about 0.001, 0.005, 0.01, 0.05, 0.1, 0.5, 1, 5 mol % or higher.

### Methods

Certain embodiments of the invention provide a method of catalyzing olefin metathesis, comprising contacting one or more reactant olefins with a catalyst composition described herein.

Olefin metathesis reactions are described herein and known in the art. Olefin metathesis reaction may occur between two substrates which are not joined by a bond (e.g., intermolecular metathesis reaction) or between two portions of a single substrate (e.g., intramolecular metathesis reaction). In certain embodiments, the reaction is cross-metathesis. In some embodiments, the reaction is an ethenolysis reaction. In certain embodiments, the reaction is ring-closing metathesis. In certain embodiments, the reaction is ring-closing metathesis, ring-opening metathesis, or cross-metathesis. In certain embodiments, the reaction is ring-closing metathesis, ring-opening metathesis, or acyclic diene metathesis.

In certain embodiments, the method comprises contacting two olefins with a catalyst composition described herein. For example, the methods couples two olefins to form a product olefin. In certain embodiments, the two olefins are the same olefin (e.g., two 1-decene molecules are coupled to produce 9-octadecene). In certain embodiments, the two olefins are different olefins (i.e., a first reactant compound and a second reactant compound), for example, the method couples allylbenzene and 1,4-diacetoxybutene.

The terms “olefin” and “alkene” as used herein refer to a compound comprising one or more C═C bond(s). In certain embodiments, the olefin has one C═C bond. In certain embodiments, the olefin has two C═C bonds.

In certain embodiments, each olefin reactant compound is independently an unsaturated, branched or unbranched, C2-C26 hydrocarbon chain, wherein one or more carbon of the hydrocarbon chain is optionally replaced with —O—, —N(R_{g})—, —S—, —Si(Rₕ)₂—, cycloalkyl, aryl, or heteroaryl, and wherein the hydrocarbon chain is optionally substituted on carbon with one or more substituents selected from the group consisting of alkoxy, alkanoyl, alkanoyloxy, alkoxycarbonyl, halo, hydroxy, amino, mercapto, oxo (═O), and thioxo (=S), wherein R_{g} and Rₕ are each independently H or alkyl (e.g., C₁-C₆).

In certain embodiments, the olefin reactant compound is a straight chain, branched or unbranched, or cyclic olefin compound of 2 to 20 carbon atoms comprising one or more double bond, and the olefin compound is optionally substituted with one or more substituents selected from the group consisting of halo, hydroxy, amino, mercapto, oxo (═O), thioxo (=S), aryl, and heteroaryl.

In certain embodiments, an olefin reactant compound is a cyclic alkene (cycloalkene).

In certain embodiments, an olefin reactant compound is a C₂-C₂₆ olefin compound. In certain embodiments, an olefin reactant compound is a C₂-C₂₄ olefin compound. In certain embodiments, an olefin reactant compound is a C₂-C₂₂ olefin compound. In certain embodiments, an olefin reactant compound is a C₂-C₂₀ olefin compound. In certain embodiments, an olefin reactant compound is a C₂-C₁₈ olefin compound. In certain embodiments, an olefin reactant compound is a C₂-C₁₆ olefin compound. In certain embodiments, an olefin reactant compound is a C₂-C₁₄ olefin compound. In certain embodiments, an olefin reactant compound is a C₂-C₁₂ olefin compound. In certain embodiments, an olefin reactant compound is a C₂-C₁₀ olefin compound. In certain embodiments, an olefin reactant compound is a C₂-C₈ olefin compound. In certain embodiments, an olefin reactant compound is a C₂-C₆ olefin compound. In certain embodiments, an olefin reactant compound is a C₂-C₄ olefin compound. In certain embodiments, an olefin reactant compound is optionally substituted with one or more substituents selected from the group consisting of halo, hydroxy, amino, mercapto, oxo (═O), thioxo (═S), alkoxy, aryl, and heteroaryl.

In certain embodiments, an olefin reactant compound is a terminal olefin (e.g., C₂-C₂₆ olefin compound), such as 1-decene or 1-octene.

In certain embodiments, an olefin reactant compound is not a terminal olefin.

In certain embodiments, an olefin reactant compound is methyl acrylate.

In certain embodiments, an olefin reactant compound is ethyl oleate.

In certain embodiments, an olefin reactant compound is allylbenzene.

In certain embodiments, an olefin reactant compound is 1,4-diacetoxybutene.

In certain embodiments, an olefin reactant compound is allyltrimethylsilane.

In certain embodiments, an olefin reactant compound is 2,2-dimethyallylmalonate.

In certain embodiments, the contacting comprises contacting at about 15-30° C., 16-29° C., 17-28° C., 18-27° C., 19-26° C., or 20-25° C.

In certain embodiments, the method is conducted for at least 5, 10, 15, 30, 45 minutes, 1 h, 2 h, 3 h, 4 h, 5 h, 6 h, 7 h, 8 h, 9 h, 10 h, 12 h, 14 h, 16 h, 18 h, 20 h, 22 h, 24 h, 36 h, 48 h, 72 h or longer.

In certain embodiments, the method is conducted at about 1000, 2000, 3000, 4000, 5000, 6000, 7000, 8000, 9000, 10000, 100000, 1000000 or higher equivalents of reactant olefin per Ru. In certain embodiments, the method is conducted at about 1000 to 1000000, 2000 to 100000, 3000 to 10000, 1000 to 100000 or 1000 to 10000 equivalents of reactant olefin per Ru.

In certain embodiments, the method has a TON (TON=turnover number at max conversion=[mol product][mol Ru]) of at least 100, 500, 1000, 2000, 3000, 4000, 5000, 6000, 7000, 8000, 9000, 10000, 20000, 30000, 40000, 50000, or higher.

In certain embodiments, the method has a TOF (TOF=initial turnover frequency (per minute)=[mol product]/[mol Ru][time]) of at least 10, 50, 100, 150, 200, 300, 400, 500, 600, 700, 800, 900, 1000, 1500, 2000, 2500, 3000, or higher.

Certain embodiments of the invention provide a method of making a catalyst composition described herein, comprising contacting a Ru compound of Formula II with a silylium on a support. For example, after contacting, the Ru compound of Formula II becomes a supported cationic Ru catalyst described herein, and silyl halide (e.g., ⁱPr₃SiCl) is formed.

In certain embodiments, the silylium has structure of ⁺Si(Rₘ)₃, wherein Rₘ is alkyl or aryl, and the aryl is optionally substituted with one or more alkyl.

In certain embodiments, Rₘ is alkyl (e.g., C1-C6, or C1-C4 alkyl). In certain embodiments, Rₘ is isopropyl.

In certain embodiments, Rₘ is aryl (e.g., phenyl) optionally substituted with one or more alkyl.

The support is an anionic solid support that provides negatively charged surface to support the silylium. Accordingly, the silylium could form ion-pairs with the anionic group on the support surface.

In certain embodiments, the support comprises metal and/or non-metal oxides. In certain embodiments, the support comprises SiO₂/Al₂O₃.

In certain embodiments, the support comprises metal oxide (e.g., Al₂O₃, ZrO₂, TiO₂, or CeO₂). In certain embodiments, the support comprises sulfated metal oxide, for example, sulfated zirconia (sulfated ZrO₂), sulfated TiO₂, or sulfated CeO₂.

In certain embodiments, the support comprises non-metal oxide, for example, silica (SiO₂).

In certain embodiments, the support comprises oxide EₓO_{y}, wherein E is metal or non-metal; x is 1 or 2; and y is 2 or 3. For example, in certain embodiments, the support comprises oxide EₓO_{y}, wherein E is Si, Al, Zr, Ti, or Ce; x is 1 or 2; and y is 2 or 3. In certain embodiments, the oxide EₓO_{y} surface may comprise-OH group. In certain embodiments, the support comprises oxide-Aluminum alkoxide (EₓO_{y}/Al(OR^{s})₃) having structure of

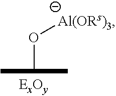

wherein R^{s} is alkyl (e.g., C1-C6 or C1-C4 alkyl such as t-butyl) optionally substituted with one or more halogen (e.g., F).

In certain embodiments, the support comprises silica-aluminum alkoxide (SiO₂/Al(OR^{s})₃), wherein R^{s} is alkyl (e.g., C1-C6 or C1-C4 alkyl such as t-butyl) optionally substituted with one or more halogen (e.g., F). In certain embodiments, R^{s} is perfluoro alkyl (e.g., perfluoro t-butyl). In certain embodiments, R^{s} is C(CF₃)₃.

In certain embodiments, the silica-aluminum alkoxide (SiO₂/Al(OR^{s})₃) has structure of

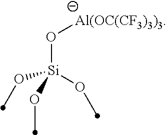

In certain embodiments, the silynium on a support has structure of

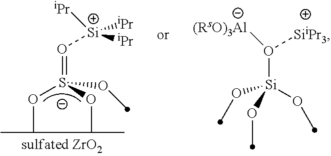

wherein alkyl (e.g., C1-C6 or C1-C4 alkyl such as t-butyl) substituted with one or more halogen (e.g., F). In certain embodiments, R^{s} is C(CF₃)₃.

The Ru compound to be contacted with the supported silylium has structure of Formula II:

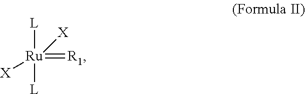

wherein
   each X is independently halogen, O(O═)CRₜ or —ORₓ, one X may be absent, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is —O(O═)CRₜ, the one oxygen of —O(O═)CRₜ is bonded with the Ru, or only one X is O(O═)CRₜ wherein the two oxygens of O(O═)CRₜ are bonded with the Ru;
   R₁ is aryl (e.g., indenylidene) or (CH)-aryl (e.g., benzylidene), wherein the aryl or (CH)-aryl is optionally substituted with one or more substituent selected from the group consisting of hydroxy, halogen, alkyl, alkoxy, nitro (—NO₂), or aryl; and
   each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl (e.g., mesityl), and wherein Rₐ is alkyl, cycloalkyl, or aryl that is optionally substituted with one or more alkyl; wherein one L is absent when only one X is O(O═)CRₜ and the two oxygen(s) of O(O═)CRₜ are bonded with the Ru;
   wherein when one X is absent, one L (a bidentate ligand when X is absent) is heterocycle, or heteroaryl substituted with one or more substituent (e.g., alkyl or adamantyl) and the substituent forms a Ru—C bond with the Ru;
   wherein Ru, together with the intervening carbon atoms of R₁, and the oxygen atom of —O— or alkoxy of one L, optionally form a ring (e.g., a five-membered ring).

In certain embodiments, one or two X is halogen.

In certain embodiments, one or two X is —ORₓ, wherein Rₓ is alkyl, alkanoyl, or aryl, and the alkyl, alkanoyl, or aryl is optionally substituted with one or more substituent of hydroxy or halogen (e.g., F). In certain embodiments, Rₓ is alkanoyl (e.g., acetyl).

In certain embodiments, one X is absent, and one L (a bidentate ligand when X is absent) is heterocycle, or heteroaryl substituted with one or more substituent (e.g., alkyl or adamantyl) and the substituent forms a Ru—C bond with the Ru.

In certain embodiments, one X is O(O═)CRₜ, wherein Rₜ is alkyl or aryl and the alkyl, or aryl is optionally substituted with one or more substituent of hydroxy or halogen (e.g., F).

In certain embodiments, each X is —O(O═)CRₜ, wherein one oxygen of X forms a Ru—O bond with the Ru and the Ru of formula II has structure of

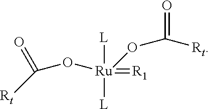

In certain embodiments, the Ru compound has structure of formula IIa,

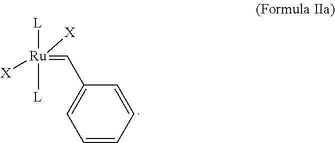

In certain embodiments, the Ru compound has structure of formula IIb,

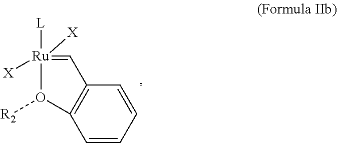

wherein R₂ is alkyl (e.g., C1-C6 alkyl such as isopropyl).

In certain embodiments, the Ru compound has structure of formula IIc,

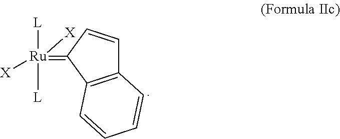

In certain embodiments, one or two L is P(Rₐ)₃, wherein Rₐ is alkyl, cycloalkyl, or aryl.

In certain embodiments, Rₐ is cycloalkyl. In certain embodiments, P(Rₐ)₃ is tricyclohexylphosphine (PCy₃).

In certain embodiments, one or two L is P(Rₐ)₃, wherein Rₐ is alkyl, or aryl that is optionally substituted with one or more alkyl. In certain embodiments, P(Rₐ)₃ is trimethylphosphine, or tri-t-butylphosphine. In certain embodiments, P(Rₐ)₃ is triphenylphosphine, or tri(o-tolyl)phosphine.

In certain embodiments, one or two L is optionally substituted heteroaryl. In certain embodiments, one or two L is pyridine.

In certain embodiments, one L is —O— or alkoxy, wherein the oxygen of —O— or alkoxy, together with the intervening carbon atoms of R₁ (e.g., =CHPh), and Ru form a ring (e.g., 5 membered ring). In certain embodiments, the alkoxy is O-isopropyl.

In certain embodiments, one or two L is optionally substituted heterocycloalkyl. In certain embodiments, one or two L is 2-imidazolidinyl. In certain embodiments, one or two L is 1,3-dimesityl-2-imidazolidinyl. In certain embodiments, one or two L is optionally substituted 2-pyrrolidinyl. In certain embodiments, one or two L is optionally substituted 5,5-dimethyl-2-pyrrolidinyl.

In certain embodiments, each L is independently selected from the group consisting of —O—, alkoxy, P(Rₐ)₃,

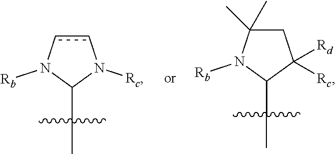

wherein R_{b}, R_{c}, R_{d} is independently H, alkyl, adamantyl, or aryl; and the aryl is optionally substituted with one or more alkyl. For example, in certain embodiments, one or two L is

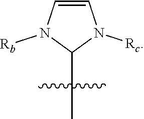

In certain embodiments, one or two L is

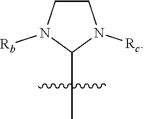

In certain embodiments, R_{b} and R_{c} are the same group. In certain embodiments, R_{b} and R_{c} are each phenyl. In certain embodiments, R_{b} and R_{c} are each independently phenyl optionally substituted with one or more alkyl. In certain embodiments, R_{b} and R_{c} are each mesityl (Mes).

In certain embodiments, R_{b} and R_{c} are not the same group.

In certain embodiments, each L is independently —O—, alkoxy, P(Rₐ)₃, or heterocycle.

In certain embodiments, each L is independently P(Rₐ)₃, or heterocycle.

In certain embodiments, each L is independently —O—, alkoxy, or P(Rₐ)₃.

In certain embodiments, each L is independently —O—, alkoxy, or heterocycle.

In certain embodiments, the Ru compound has structure of formula IId,

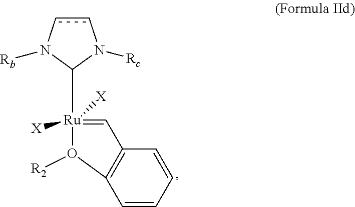

wherein R₂ is alkyl (e.g., isopropyl).

In certain embodiments, only one X is absent, and a substituent on one L (wherein L is heterocycle or heteroaryl) also forms a Ru—C bond. For example, in certain embodiments, one of R_{b} and R_{c} forms a Ru—C bond with the Ru. Accordingly, in certain embodiments, the cationic Ru catalyst has structure of Formula Ile:

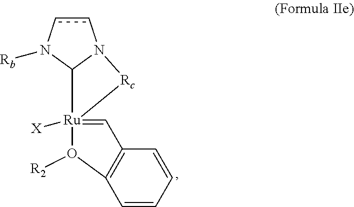

wherein R₂ is alkyl (e.g., C1-C6 alkyl). In certain embodiments, R₂ is isopropyl.

In certain embodiments, R_{c} is adamantyl or alkyl. In certain embodiments, R_{c} is adamantyl. In certain embodiments, R_{c} is adamantyl and R_{b} is optionally substituted aryl.

In certain embodiments, R₁ is aryl (e.g., indenylidene) or (CH)-aryl (e.g., benzylidene), wherein the aryl or (CH)-aryl is optionally substituted with substituent Y, which is selected from the group consisting of hydroxy, halogen, alkyl, alkoxy, nitro (—NO₂), or aryl.

Accordingly, in one embodiment, the following exemplary ruthenium catalysts can be used to prepare cationic ruthenium catalysts of the invention. Thus, in certain embodiments, the Ru compound of formula II has structure of

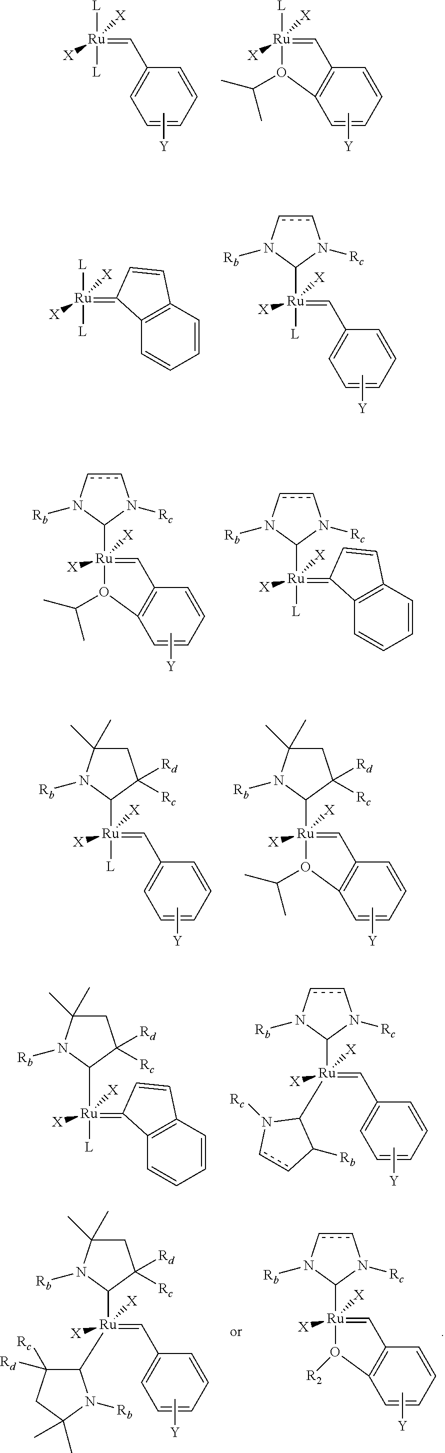

In certain embodiments, the Ru compound of formula II has structure of

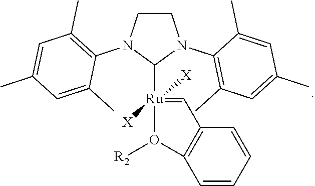

In certain embodiments, the the Ru compound of formula II has structure of

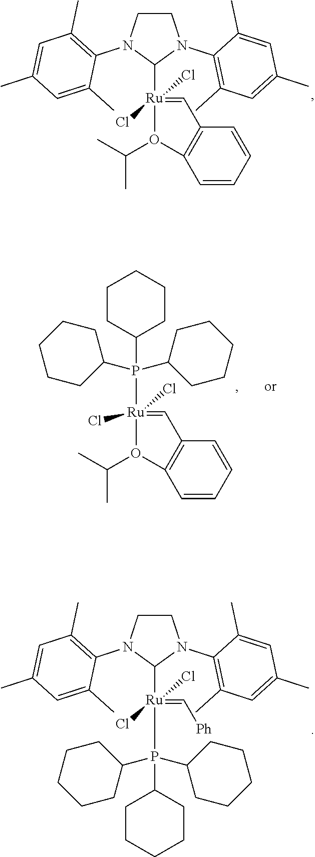

In certain embodiments, the the Ru compound of formula II has structure of

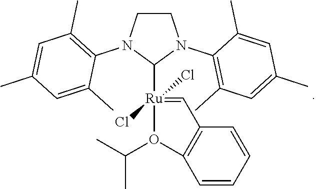

In certain embodiments, the contacting comprises mixing a Ru compound of Formula II with a silylium on a support in a non-polar organic solvent (e.g., an alkane such as pentane). In certain embodiments, the contacting comprises contacting (e.g., mixing) at about-40° C., −30° C., −20° C., −10° C., 0° C., 10° C., 20° C., 30° C., 40° C., 50° C., 60° C., 70° C., or 80° C. In certain embodiments, the contacting comprises contacting (e.g., mixing) at about −40-80° C., −30-70° C., −20-60° C., −10-50° C., 0-40° C. or 10-30° C. In certain embodiments, the contacting comprises contacting (e.g., mixing) at about 15-30° C., 16-29° C., 17-28° C., 18-27° C., 19-26° C., or 20-25° C.

In certain embodiments, the contacting (e.g., mixing) is conducted for a duration of about 1 minute to 72 hrs, 5 min to 48 hrs, 10 min to 24 hrs, 15 min to 12 hrs, 20 min to 6 hrs, 25 min to 3 hrs, 30 min to 1 hour. In certain embodiments, the method is conducted for at least 5, 10, 15, 30, 45 minutes, 1 h, 2 h, 3 h, 4 h, 5 h, 6 h, 7 h, 8 h, 9 h, 10 h, 12 h, 14 h, 16 h, 18 h, 20 h, 22 h, 24 h, 36 h, 48 h, 72 h or longer.

In certain embodiments, contacting (e.g., mixing) is conducted at about −220° C. to −80° C. (e.g., about −196° C.) followed by mixing at about 15-30° C., 16-29° C., 17-28° C., 18-27° C., 19-26° C., or 20-25° C.

In certain embodiments, the method of making a catalyst composition described herein further comprises separating the solid with the non-polar organic solvent (e.g., filtering).

In certain embodiments, the method of making a catalyst composition described herein further comprises drying the product solid under vacuum.

### Certain Definitions

The following definitions are used, unless otherwise described: halo or halogen is fluoro, chloro, bromo, or iodo. Alkyl, alkoxy, etc. denote both straight and branched groups; but reference to an individual radical such as propyl embraces only the straight chain radical, a branched chain isomer such as isopropyl being specifically referred to.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, (C₁-C₆)alkyl, (C₂-C₆)alkyl, (C₁-C₃)alkyl, and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and higher homologs and isomers. (C₁-C₆)alkyl can be methyl, ethyl, propyl, isopropyl, butyl, iso-butyl, sec-butyl, pentyl, 3-pentyl, or hexyl.

The term “alkoxy” refers to an alkyl groups attached to the remainder of the molecule via an oxygen atom (“oxy”). For example, (C₁-C₆)alkoxy can be methoxy, ethoxy, propoxy, isopropoxy, butoxy, iso-butoxy, sec-butoxy, pentoxy, 3-pentoxy, or hexyloxy.

The term “halo” or “halogen” refers to bromo, chloro, fluoro or iodo. In some embodiments, halogen refers to chloro or fluoro. In some embodiments, halogen refers to fluoro.

The term “cycloalkyl” refers to a saturated or partially unsaturated (non-aromatic) all carbon ring having 3 to 8 carbon atoms (i.e., (C₃-C₈)carbocycle). The term also includes multiple condensed, saturated all carbon ring systems (e.g., ring systems comprising 2, 3 or 4 carbocyclic rings). Accordingly, carbocycle includes multicyclic carbocyles such as a bicyclic carbocycles (e.g., bicyclic carbocycles having about 3 to 15 carbon atoms, about 6 to 15 carbon atoms, or 6 to 12 carbon atoms such as bicyclo[3.1.0]hexane and bicyclo[2.1.1]hexane), and polycyclic carbocycles (e.g tricyclic and tetracyclic carbocycles with up to about 20 carbon atoms). The rings of the multiple condensed ring system can be connected to each other via fused, spiro and bridged bonds when allowed by valency requirements. For example, multicyclic carbocyles can be connected to each other via a single carbon atom to form a spiro connection (e.g., spiropentane, spiro[4,5]decane, etc), via two adjacent carbon atoms to form a fused connection (e.g., carbocycles such as decahydronaphthalene, norsabinane, norcarane) or via two non-adjacent carbon atoms to form a bridged connection (e.g., norbornane, bicyclo[2.2.2]octane, etc). Non-limiting examples of cycloalkyls include cyclopropyl, cyclobutyl, cyclopentyl, cyclohexyl, bicyclo[2.2.1]heptane, pinane, and adamantane. (C₃-C₆) cycloalkyl can be cyclopropyl, cyclobutyl, cyclopentyl, or cyclohexyl.

The term “aryl” as used herein refers to a single all carbon aromatic ring or a multiple condensed all carbon ring system wherein at least one of the rings is aromatic. For example, in certain embodiments, an aryl group has 6 to 20 carbon atoms, 6 to 14 carbon atoms, 6 to 12 carbon atoms, or 6 to 10 carbon atoms. Aryl includes a phenyl radical. Aryl also includes multiple condensed carbon ring systems (e.g., ring systems comprising 2, 3 or 4 rings) having about 9 to 20 carbon atoms in which at least one ring is aromatic and wherein the other rings may be aromatic or not aromatic (i.e., cycloalkyl. The rings of the multiple condensed ring system can be connected to each other via fused, spiro and bridged bonds when allowed by valency requirements. It is to be understood that the point of attachment of a multiple condensed ring system, as defined above, can be at any position of the ring system including an aromatic or a carbocycle portion of the ring. Non-limiting examples of aryl groups include, but are not limited to, phenyl, indenyl, indanyl, naphthyl, 1, 2, 3, 4-tetrahydronaphthyl, anthracenyl, and the like.

The term “heterocycle” refers to a single saturated or partially unsaturated ring that has at least one atom other than carbon in the ring, wherein the atom is selected from the group consisting of oxygen, nitrogen and sulfur; the term also includes multiple condensed ring systems that have at least one such saturated or partially unsaturated ring, which multiple condensed ring systems are further described below. Thus, the term includes single saturated or partially unsaturated rings (e.g., 3, 4, 5, 6 or 7-membered rings) from about 1 to 6 carbon atoms and from about 1 to 3 heteroatoms selected from the group consisting of oxygen, nitrogen and sulfur in the ring. The sulfur and nitrogen atoms may also be present in their oxidized forms. Exemplary heterocycles include but are not limited to azetidinyl, tetrahydrofuranyl and piperidinyl. The term “heterocycle” also includes multiple condensed ring systems (e.g., ring systems comprising 2, 3 or 4 rings) wherein a single heterocycle ring (as defined above) can be condensed with one or more groups selected from cycloalkyl, aryl, and heterocycle to form the multiple condensed ring system. The rings of the multiple condensed ring system can be connected to each other via fused, spiro and bridged bonds when allowed by valency requirements. It is to be understood that the individual rings of the multiple condensed ring system may be connected in any order relative to one another. It is also to be understood that the point of attachment of a multiple condensed ring system (as defined above for a heterocycle) can be at any position of the multiple condensed ring system including a heterocycle, aryl and carbocycle portion of the ring. In one embodiment the term heterocycle includes a 3-15 membered heterocycle. In one embodiment the term heterocycle includes a 3-10 membered heterocycle. In one embodiment the term heterocycle includes a 3-8 membered heterocycle. In one embodiment the term heterocycle includes a 3-7 membered heterocycle. In one embodiment the term heterocycle includes a 3-6 membered heterocycle. In one embodiment the term heterocycle includes a 4-6 membered heterocycle. In one embodiment the term heterocycle includes a 3-10 membered monocyclic or bicyclic heterocycle comprising 1 to 4 heteroatoms. In one embodiment the term heterocycle includes a 3-8 membered monocyclic or bicyclic heterocycle heterocycle comprising 1 to 3 heteroatoms. In one embodiment the term heterocycle includes a 3-6 membered monocyclic heterocycle comprising 1 to 2 heteroatoms. In one embodiment the term heterocycle includes a 4-6 membered monocyclic heterocycle comprising 1 to 2 heteroatoms. Exemplary heterocycles include, but are not limited to aziridinyl, azetidinyl, pyrrolidinyl, piperidinyl, homopiperidinyl, morpholinyl, thiomorpholinyl, piperazinyl, tetrahydrofuranyl, dihydrooxazolyl, tetrahydropyranyl, tetrahydrothiopyranyl, 1,2,3,4-tetrahydroquinolyl, benzoxazinyl, dihydrooxazolyl, chromanyl, 1,2-dihydropyridinyl, 2,3-dihydrobenzofuranyl, 1,3-benzodioxolyl, 1,4-benzodioxanyl, spiro[cyclopropane-1,1′-isoindolinyl]-3′-one, isoindolinyl-1-one, 2-oxa-6-azaspiro[3.3]heptanyl, imidazolidin-2-one imidazolidine, pyrazolidine, butyrolactam, valerolactam, imidazolidinone, hydantoin, dioxolane, phthalimide, 1,4-dioxane, 2-imidazolidinyl, 1,3-dimesityl-2-imidazolidinyl, and 5,5-dimethyl-2-pyrrolidinyl.

The term “heteroaryl” as used herein refers to a single aromatic ring that has at least one atom other than carbon in the ring, wherein the atom is selected from the group consisting of oxygen, nitrogen and sulfur; “heteroaryl” also includes multiple condensed ring systems that have at least one such aromatic ring, which multiple condensed ring systems are further described below. Thus, “heteroaryl” includes single aromatic rings of from about 1 to 6 carbon atoms and about 1-4 heteroatoms selected from the group consisting of oxygen, nitrogen and sulfur. The sulfur and nitrogen atoms may also be present in an oxidized form provided the ring is aromatic. Exemplary heteroaryl ring systems include but are not limited to pyridyl, pyrimidinyl, oxazolyl or furyl. “Heteroaryl” also includes multiple condensed ring systems (e.g., ring systems comprising 2, 3 or 4 rings) wherein a heteroaryl group, as defined above, is condensed with one or more rings selected from cycloalkyl, aryl, heterocycle, and heteroaryl. It is to be understood that the point of attachment for a heteroaryl or heteroaryl multiple condensed ring system can be at any suitable atom of the heteroaryl or heteroaryl multiple condensed ring system including a carbon atom and a heteroatom (e.g., a nitrogen). Exemplary heteroaryls include but are not limited to pyridyl, pyrrolyl, pyrazinyl, pyrimidinyl, pyridazinyl, pyrazolyl, thienyl, indolyl, imidazolyl, triazolyl, tetrazolyl, oxazolyl, isoxazolyl, thiazolyl, furyl, oxadiazolyl, thiadiazolyl, quinolyl, isoquinolyl, benzothiazolyl, benzoxazolyl, indazolyl, quinoxalyl, and quinazolyl.

As used herein, the term “heteroatom” is meant to include oxygen (O), nitrogen (N), sulfur(S) and silicon (Si).

As used herein a wavy line “ [symbol] ” that intersects a bond in a chemical structure indicates the point of attachment of the bond that the wavy bond intersects in the chemical structure to the remainder of a molecule.

When a bond in a compound formula herein is drawn in a non-stereochemical manner (e.g. flat), the atom to which the bond is attached includes all stereochemical possibilities. When a bond in a compound formula herein is drawn in a defined stereochemical manner (e.g. bold, bold-wedge, dashed or dashed-wedge), it is to be understood that the atom to which the stereochemical bond is attached is enriched in the relative stereoisomer depicted unless otherwise noted. In one embodiment, the compound may be at least 51% the relative stereoisomer depicted. In another embodiment, the compound may be at least 60% the relative stereoisomer depicted. In another embodiment, the compound may be at least 80% the relative stereoisomer depicted. In another embodiment, the compound may be at least 90% the relative stereoisomer depicted. In another embodiment, the compound may be at least 95% the relative stereoisomer depicted. In another embodiment, the compound may be at least 99% the relative stereoisomer depicted.

Certain embodiments of the invention will be illustrated in the following non-limiting Example.

### Example 1 Ruthenium Catalysts for Olefin Metathesis

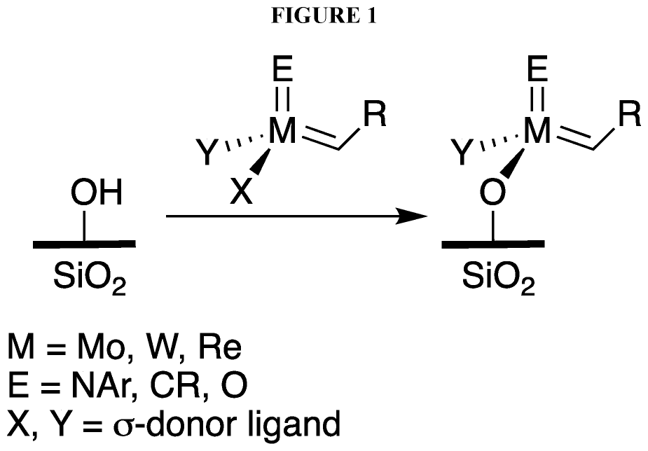

The incorporation of organometallic groups onto oxide surfaces is a strategy to access more efficient and selective heterogeneous catalysts.¹ One of the success stories in this area is the development of well-defined heterogeneous catalysts for olefin metathesis, FIG. 1.² The olefin metathesis reaction was discovered in studies of heterogeneous catalysts containing tungsten, molybdenum, or rhenium oxides supported on silica or alumina. From these studies the industrially relevant WO₃/SiO₂ catalyst emerged, but this catalyst operates at high temperatures and is incompatible with functional groups.³ Contrast this behavior with the organometallic do alkylidene catalysts⁴ that follow the metathesis mechanism proposed by Chauvin and are active at room temperature and compatible with a wide array of functional groups. Incorporating do alkylidene organometallics onto oxides results in very active olefin metathesis catalysts; in some cases the well-defined heterogeneous organometallic is more active than closely related catalysts in solution.²

The reaction shown in FIG. 1 involves protonolysis of an M-X group (X=alkyl, amido, alkoxide, etc.) by an —OH group on the oxide (usually SiO₂) surface. This is the most common route to generate a well-defined organometallic on a surface,⁵ but is limited to polarized M-X groups. For example, reactions of L₂Ru(═CHR)Cl₂, common ruthenium catalysts for olefin metathesis,⁶ are incompatible with this reaction. Thus strategies to heterogenize ruthenium catalysts onto oxides shown in FIG. 2A involve further derivatization followed by reaction with an oxide, or multi-step syntheses to access materials containing reactive groups that bind (PCy₃)₂Ru(═CHR)Cl₂ or related ruthenium compounds to form well-defined ruthenium benzylidenes.⁷

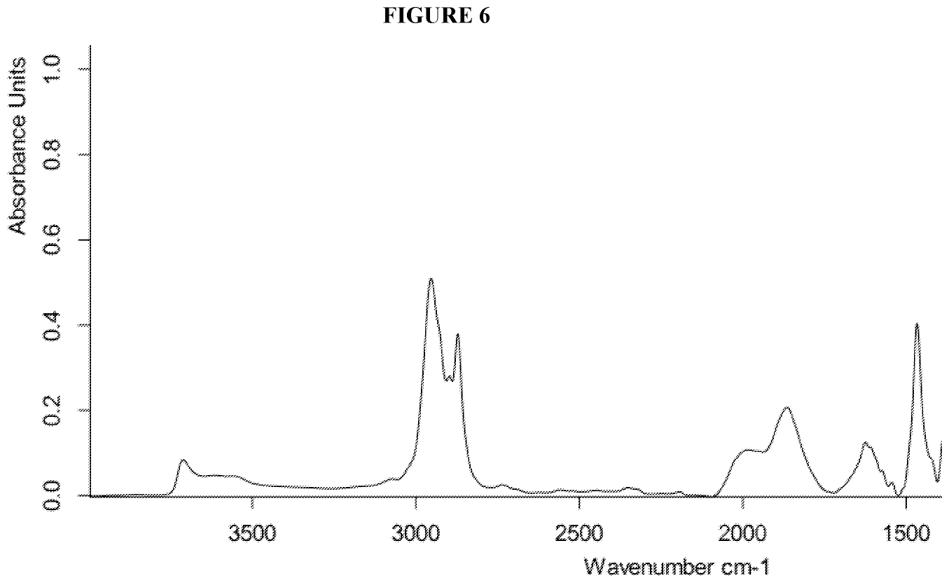

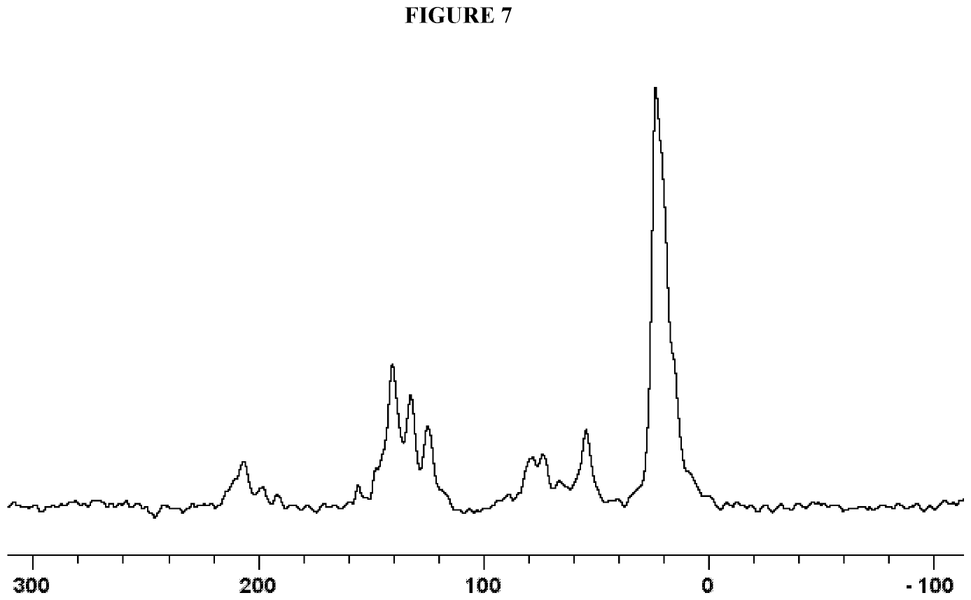

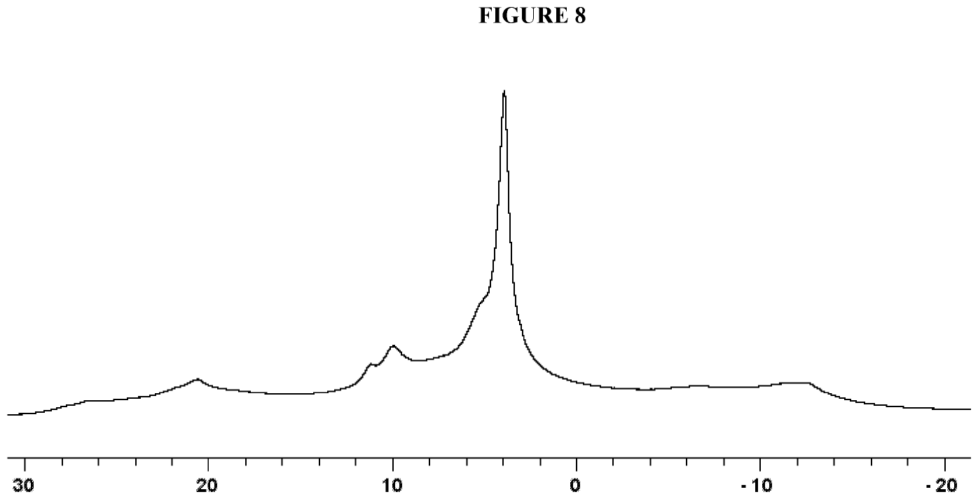

We recently described oxides capped with silylium-like ions.⁸ Silylium-like ions (R₃Si⁺) are very strong Lewis acids⁹ that abstract halides from transition metal, lanthanide, or actinide complexes to form R₃Si—X (X=halide) and an ion-pair.¹⁰ Oxides capped with silylium-like ions behave similarly,¹¹ which provides a complementary methodology to the common protonolysis route typified in FIG. 1 to form well-defined heterogeneous from readily available precursors. This Example describes the exemplary reaction of 2^{nd} generation Grubbs-Hoveyda (GH-II) catalyst¹² with [ⁱPr₃Si][(R^{F}O)₃Al—OSi≡)] (R^{F}=C(CF₃)₃) to form a [(IMes)Ru(═CH (o-OⁱPr—C₆H₄)Cl][(R^{F}O)₃Al—OSi≡)] (1), FIG. 2B, which is exceptionally active in olefin metathesis reactions. FTIR spectrum, 13C{1H} HP-DEC MAS NMR spectrum, and 1H NMR spectrum of 1 are shown in FIG. 6, FIG. 7, and FIG. 8 respectively.

### Synthesis and Characterization

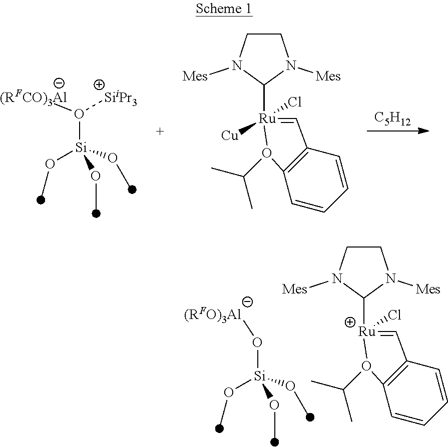

Synthesis of 1: [ⁱPr₃Si][≡Si—OAl(OR^{F})₃] (2 g, 0.48 mmol=Si—OH—Al(OR^{F})₃) and Grubbs-Hoveyda Second Generation Catalyst (0.313 g, 0.50 mmol) were loaded into a teflon-valved flask containing two arms separated by a medium porosity frit (double Schlenk) and evacuated under diffusion pump vacuum. Pentane (˜10 mL) was transferred to the flask at −196° C. The slurry was warmed up to room temperature and stirred for 30 minutes. The green solution was filtered to the other side of the double Schlenk. The remaining solid was washed by condensing solvent from the other arm of the double Schlenk at −196° C., warming to room temperature, stirring for 2 minutes, and filtering the solvent back to the other side of the flask. This was repeated until the solution remained colorless upon stirring, then filtered a final time. The solid was dried under diffusion pump vacuum for 1 hour. The brown material was stored in a glovebox freezer at −20° C. Elemental analysis: 2.2% Ru.

Methods to prepare a silylium on a support are described herein and known in art, for example, in D Culver, et al., Chem. Sci., 2020, 11, 1510-1517 (DOI: 10.1039/C9SC05904K) and D Culver, et al., Angew Chem Int Ed Engl. 2018 Nov. 5; 57 (45): 14902-14905 (doi: 10.1002/anie.201809199), the entire contents of which are incorporated by reference herein.

### NMR Spectroscopy

Solution NMR spectra at 7.05 T were acquired on an Avance Bruker 300. ¹H NMR spectra were referenced to the natural abundance residual solvent peak. Solid state NMR spectra at UC Riverside were recorded in 4 mm zirconia rotors at 8-12 KHz spinning at the magic angle at 14.1 T on an Avance Bruker NEO600 spectrometer equipped with a standard-bore magnet.

### Quantification of Triisopropylsilyl Chloride

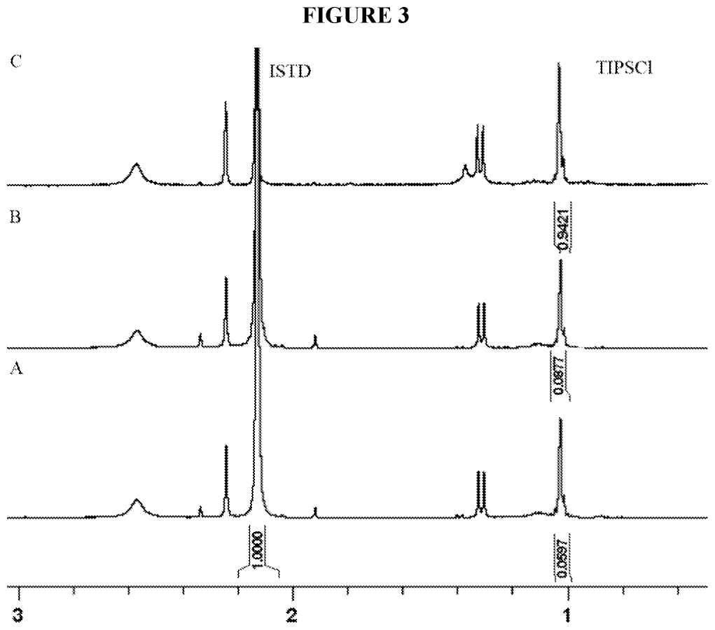

In a sealed J-young NMR tube, [ⁱPr₃Si][≡Si—OAl(OR^{F})₃] (50 mg, 0.012 mmol ≡Si—OH—Al(OR^{F})₃), Grubbs-Hoveyda Second Generation Catalyst (10 mg, 0.016 mmol), and hexamethyl benzene were slurred in C₆D₆. The reaction was periodically shaken over a period of 30 minutes, before collecting an NMR spectrum. Hexamethyl benzene serves as an internal standard to quantitate the amount of triisopropylsilyl chloride (TIPSCl) that comes off during the reaction (FIG. 3).

TABLE 1
Quantification of TIPSCl.

| | A | B | C |
|---|---|---|---|
| [ⁱPr₃Si][≡Si—OAl(OR^{F})₃] | 33.1 | 33.9 | 57.5 |
| (mg) | | | |
| ISTD (mg) | 11.1 | 8.3 | 1.2 |
| TIPSCl (mg) | 6.1 | 6.5 | 1.1 |
| mmol/g Ru | 0.17 | 0.18 | 0.18 |

### Quantification of GH2

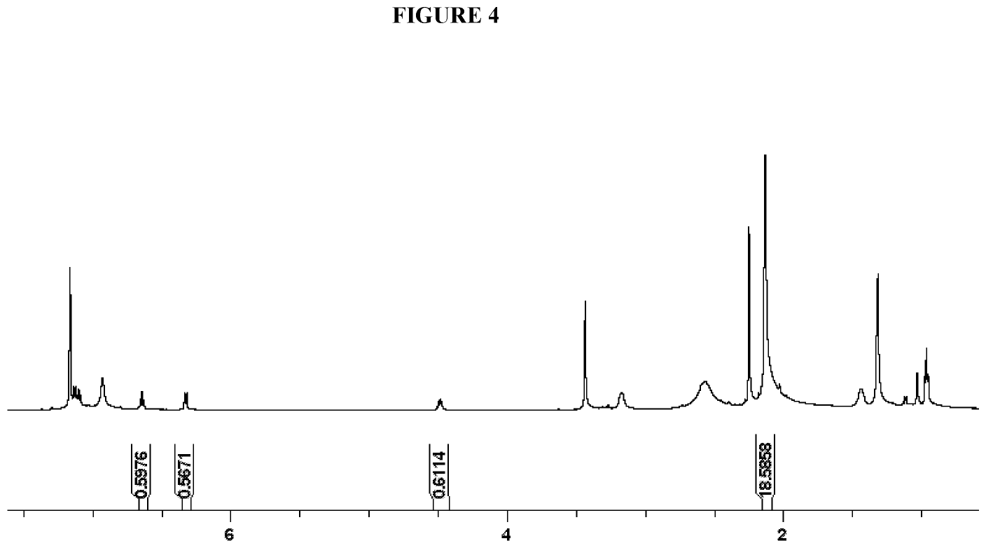

In a sealed J-young NMR tube, 1 (50 mg, 0.009 mmol Ru), tetrabutylammonium chloride (2.5 mg, 0.009 mmol), and hexamethyl benzene were slurred in C₆D₆. The reaction was sonicated over a period of 30 minutes, before collecting an NMR spectrum. Hexamethyl benzene serves as an internal standard to quantitate the amount of Ru that comes off during the reaction (FIG. 4); aromatic and aliphatic protons on the alkylidene are integrated against the reference standard.

TABLE 2
Quantification of GH2.

| | A |
|---|---|
| 1 (mg) | 40.0 |
| ISTD (mg) | 4.5 |
| GH2 (mg) | 11.2 |
| mmol/g Ru | 0.18 |

### Quantification of GH2

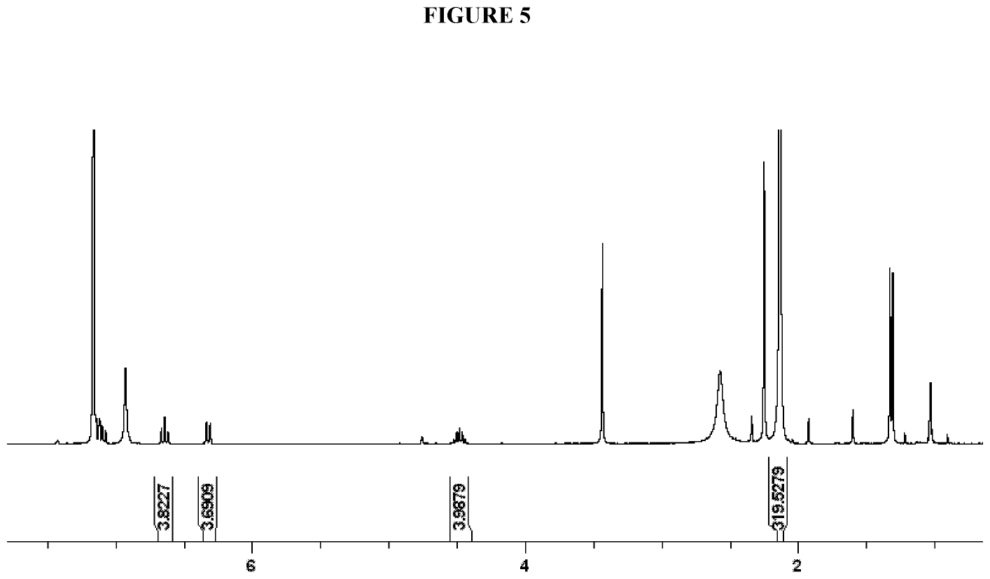

In a sealed J-young NMR tube, 1 (50 mg, 0.009 mmol Ru), ammonium chloride (0.5 mg, 0.009 mmol), and hexamethyl benzene were slurred in C₆D₆. The reaction was sonicated over a period of 30 minutes, before collecting an NMR spectrum. Hexamethyl benzene serves as an internal standard to quantitate the amount of Ru that comes off during the reaction (FIG. 5); aromatic and aliphatic protons on the alkylidene are integrated against the reference standard.

TABLE 3
Quantification of GH2.

| | A |
|---|---|
| 1 (mg) | 55.5 |
| ISTD (mg) | 9.0 |
| GH2 (mg) | 12.2 |
| mmol/g Ru | 0.22 |

### Metathesis

### Metathesis of 1-Decene

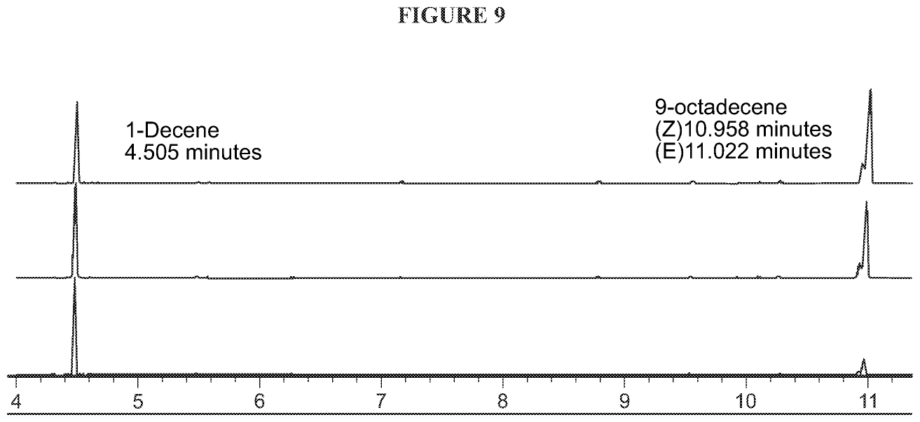

1 (5 mg, 1.1 μmol Ru) was added to a 20 mL reaction vessel, then charged with 0.5 mL of toluene. On a stir plate, 10 mL of 1.1M 1-decene in toluene is syringed into the reaction vessel. The final concentration of 1-decene is 1.05M, which contains 10000 equivalents of olefin per Ru. The reaction was monitored at regular time points by both GC-FID and NMR. A representative conversion plot obtained from NMR data for this metathesis experiment is shown in FIG. 9. NMR data assigns each of these species as E or Z olefins that were not resolved using this GC method.

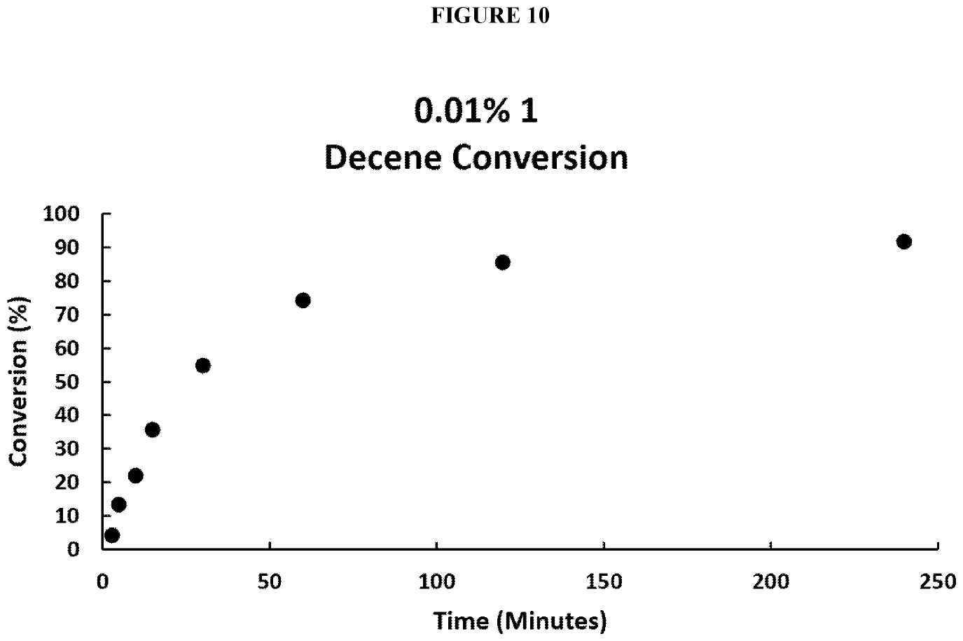

TABLE 4
Conversion of 1-decene (also see FIG. 10).

| | Percent Conversion |
|---|---|
| Min. | 1 |
| 3 | 4.2 |
| 5 | 13.3 |
| 10 | 22.0 |
| 15 | 35.7 |
| 30 | 54.8 |
| 60 | 74.1 |
| 120 | 85.5 |
| 240 | 91.6 |

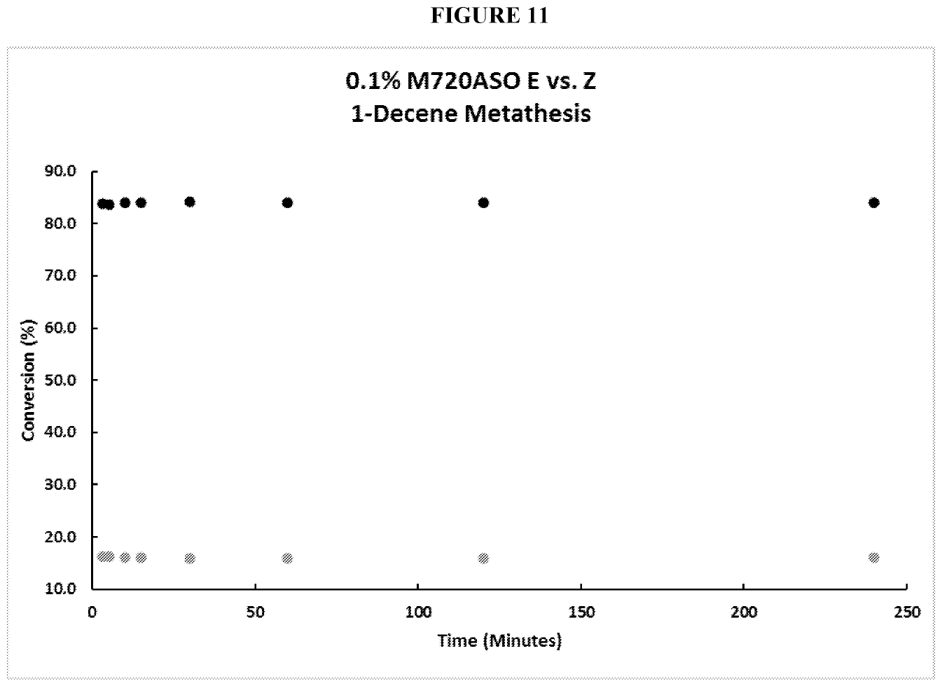

TABLE 5
E/Z decene conversion with supported catalyst (also see FIG. 11).

M720ASO

| Min. | E | Z |
|---|---|---|
| 3 | 83.8 | 16.2 |
| 5 | 83.7 | 16.3 |
| 10 | 84.0 | 16.0 |
| 15 | 84.0 | 16.0 |
| 30 | 84.1 | 15.9 |
| 60 | 84.0 | 16.0 |
| 120 | 84.1 | 15.9 |
| 240 | 84.0 | 16.0 |

### Leaching Experiment

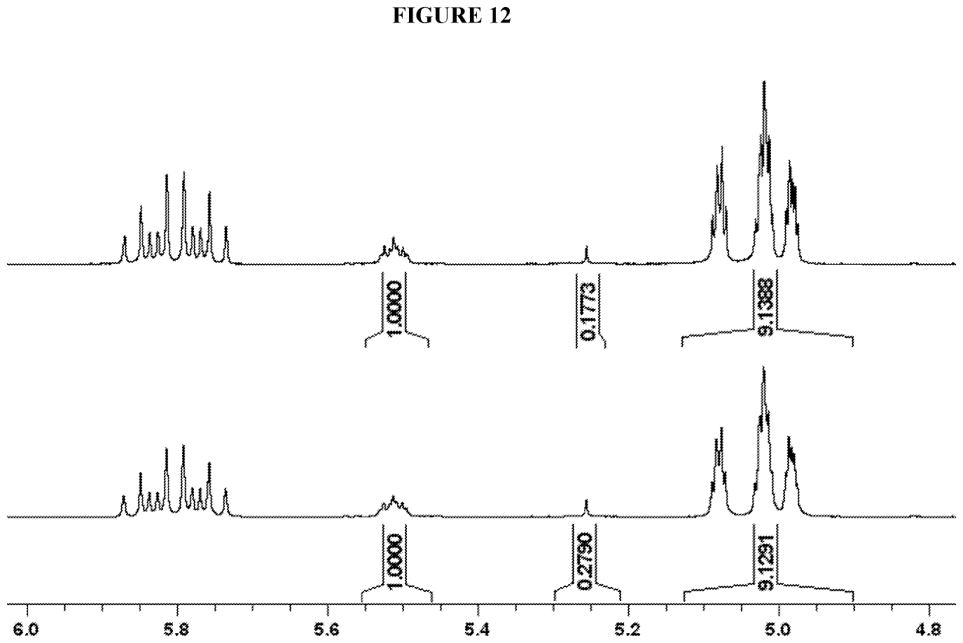

1 (5 mg, 1.1 μmol Ru) and decene (154 mg, 1.1 mmol) were added to a micro reaction vessel. The neat reaction contains 1000 equivalents of olefin per Ru. After 3 minutes the entire reaction mixture was filtered through 3 separate pipette filters. An aliquot of the filtered reaction mixture was used to prepare an NMR inside of the glove box that was analyzed immediately and over the course of five days; no increase in metathesis or isomerization products were detected over the course of the experiment (FIG. 12).

### Maximum TON Experiment

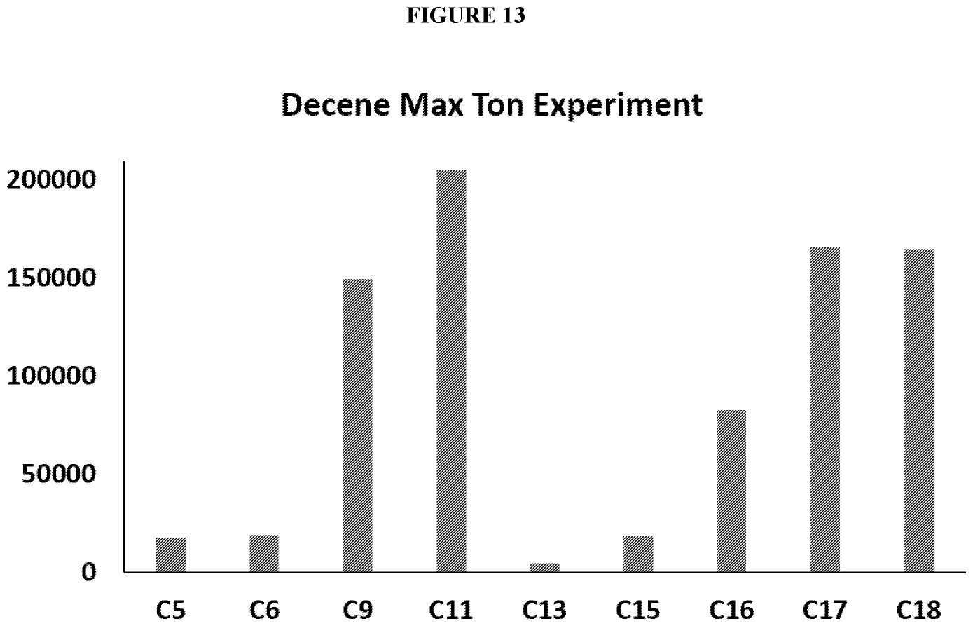

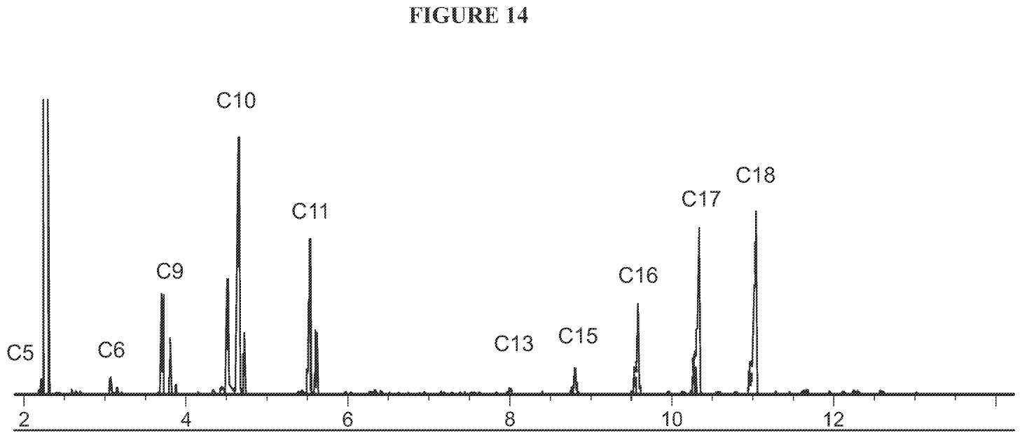

1 (5 mg, 1.1 μmol Ru) and decene (180 mL, 0.95 mol) were added to a 350 mL Teflon sealed reaction vessel. The neat reaction contains >1,250,000 equivalents of olefin per Ru. A representative bar graph obtained from GC-FID data obtained at 35 days for this metathesis experiment is shown in FIG. 13. The GC-FID is complex due to isomerization of 1-decene under the reaction conditions, and subsequent cross metathesis and ethenolysis reactions that occur under these conditions (FIG. 14). GC-MS data assigns each of these species as E/Z olefins that were not resolved using this method.

### Metathesis of Allyltrimethylsilane

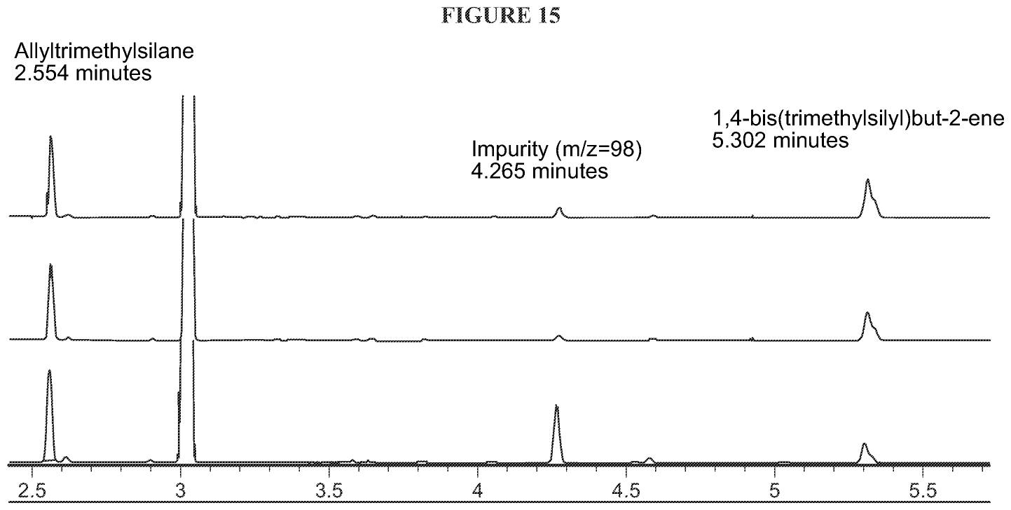

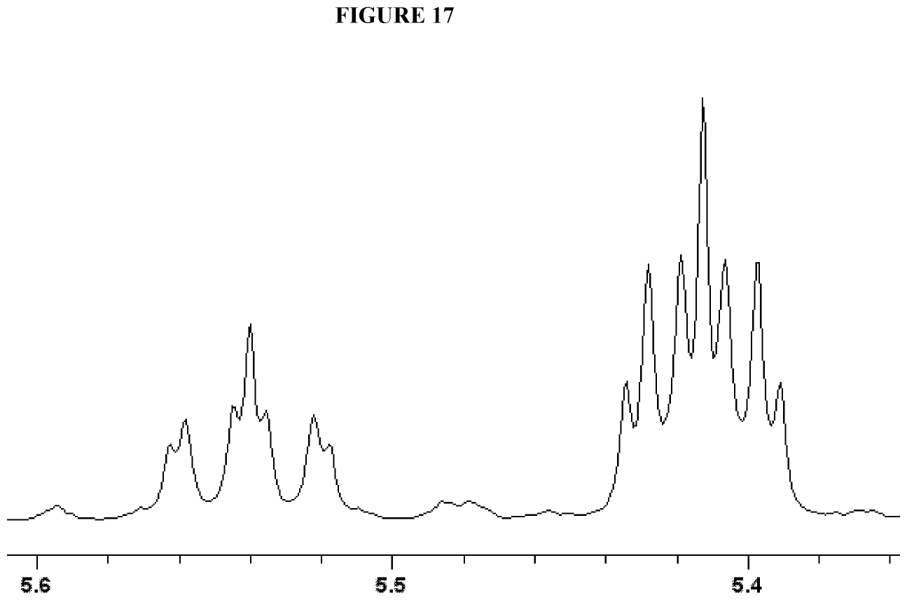

1 (5 mg, 1.1 μmol Ru) was added to a micro reaction vessel, then charged with 0.5 mL of toluene. On a stir plate, 1 mL of 1.1M allyltrimethylsilane in toluene is syringed into the reaction vessel. The final concentration of allyltrimethylsilane is 0.667M, which contains 1000 equivalents of olefin per Ru. The reaction was monitored at regular time points by both GC-FID and NMR. A representative conversion plot obtained from GC-FID data for this metathesis experiment is shown in FIG. 15. NMR data (FIG. 17) assigns each of these species as E or Z olefins that were not resolved using this GC method.

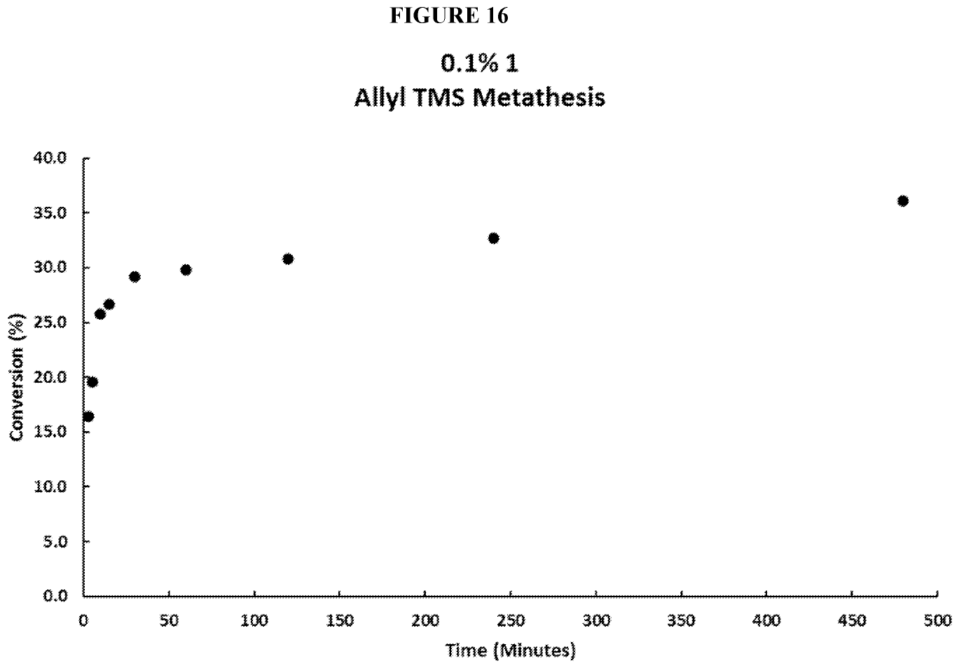

TABLE 6
Conversion of allyltrimethylsilane (also see FIG. 16).

| | % Conversion |
|---|---|
| Min. | 1 |
| 3 | 16.4 |
| 5 | 19.6 |
| 10 | 25.7 |
| 15 | 26.7 |
| 30 | 29.2 |
| 60 | 29.8 |
| 120 | 30.8 |
| 240 | 32.7 |
| 480 | 36.1 |

### Metathesis of allylbenzene

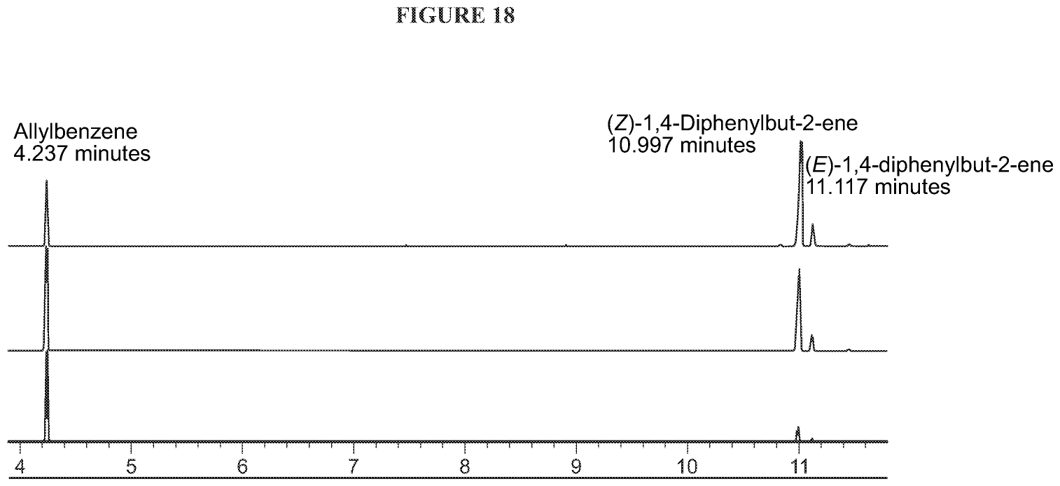

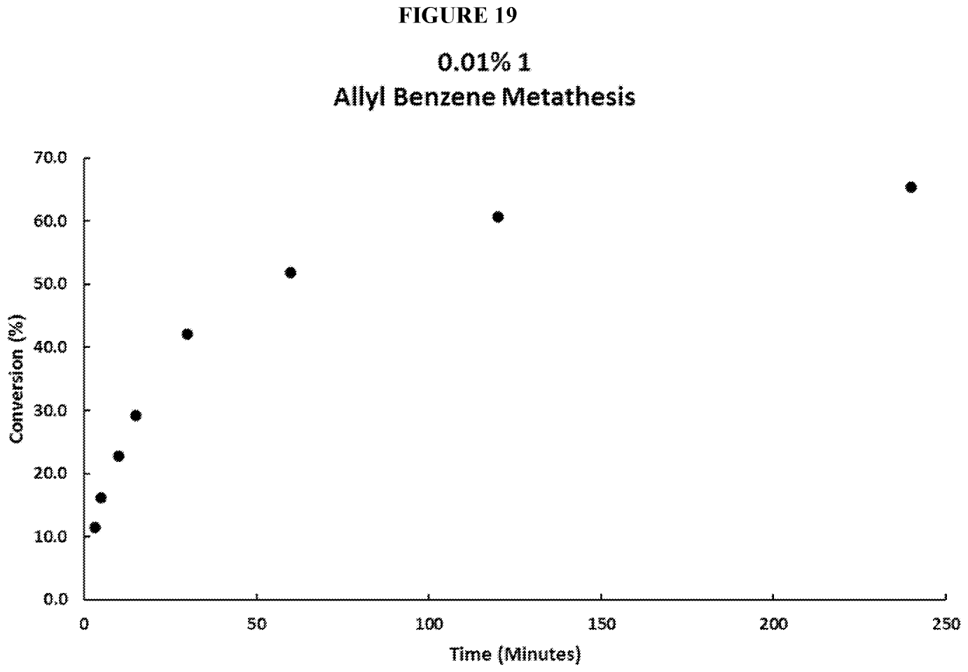

1 (5 mg, 1.1 μmol Ru) was added to a 20 mL reaction vessel, then charged with 0.5 mL of toluene. On a stir plate, 10 mL of 1.1M allylbenzene in toluene is syringed into the reaction vessel. The final concentration of allylbenzene is 1.05M, which contains 10000 equivalents of olefin per Ru. The reaction was monitored at regular time points by both GC-FID and NMR. A representative conversion plot obtained from GC-FID data for this metathesis experiment is shown in FIG. 18 and FIG. 19. GC-MS data assigns each of these species as E or Z olefins using this GC method.

TABLE 7
Allylbenzene metathesis conversion (also see FIG. 19).

| | % | | |
|---|---|---|---|
| Min. | Conversion | E | Z |
| 3 | 11.4 | 1.5 | 9.9 |
| 5 | 16.2 | 2.1 | 14.1 |
| 10 | 22.8 | 2.9 | 19.9 |
| 15 | 29.2 | 3.8 | 25.4 |
| 30 | 42.1 | 5.4 | 36.7 |
| 60 | 51.8 | 6.8 | 45.1 |
| 120 | 60.7 | 8.0 | 52.7 |
| 240 | 65.3 | 8.7 | 56.6 |
| 1440 | 70.8 | 9.2 | 61.6 |

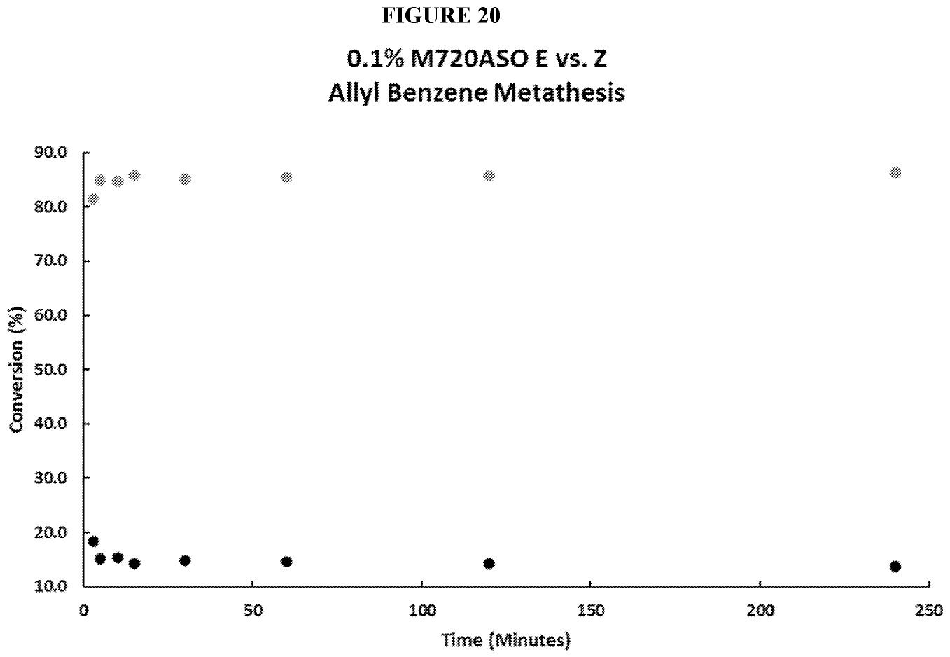

TABLE 8
Allylbenzene metathesis % E/Z conversion (also see FIG. 20).

M720ASO

| Min. | E | Z |
|---|---|---|
| 3 | 18.5 | 81.5 |
| 5 | 15.2 | 84.8 |
| 10 | 15.3 | 84.7 |
| 15 | 14.2 | 85.8 |
| 30 | 14.8 | 85.2 |
| 60 | 14.6 | 85.4 |
| 120 | 14.3 | 85.7 |
| 240 | 13.7 | 86.3 |

### Metathesis of Methyl Acrylate

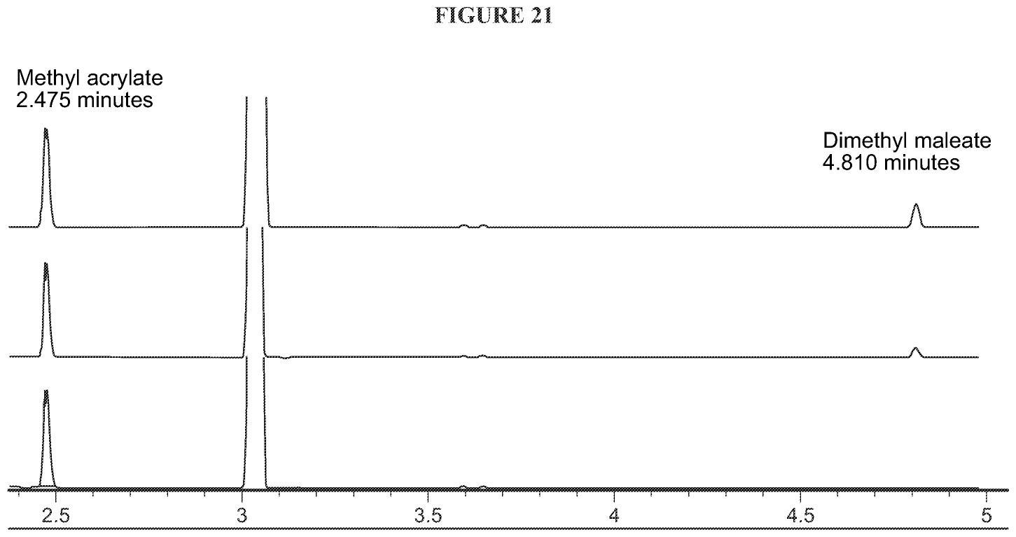

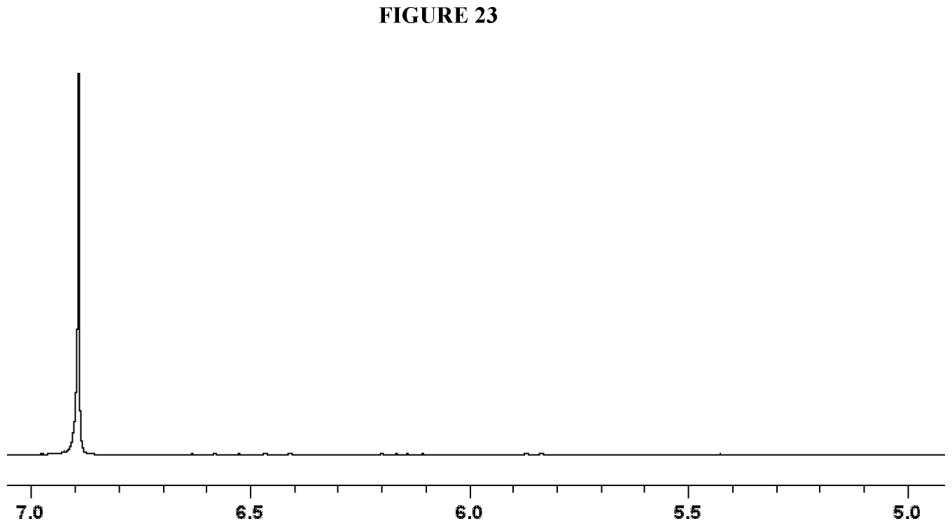

1 (5 mg, 1.1 μmol Ru) was added to a micro reaction vessel, then charged with 0.5 mL of toluene. On a stir plate, 1 mL of 1.1M methyl acrylate in toluene is syringed into the reaction vessel. The final concentration of methyl acrylate is 0.667M, which contains 1000 equivalents of olefin per Ru. The reaction was monitored at regular time points by both GC-FID and NMR. A representative conversion plot obtained from GC-FID data for this metathesis experiment is shown in FIG. 21. FIG. 23 shows the 1H NMR of the olefin region of the isolated product after the reaction was stopped at 24 hours.

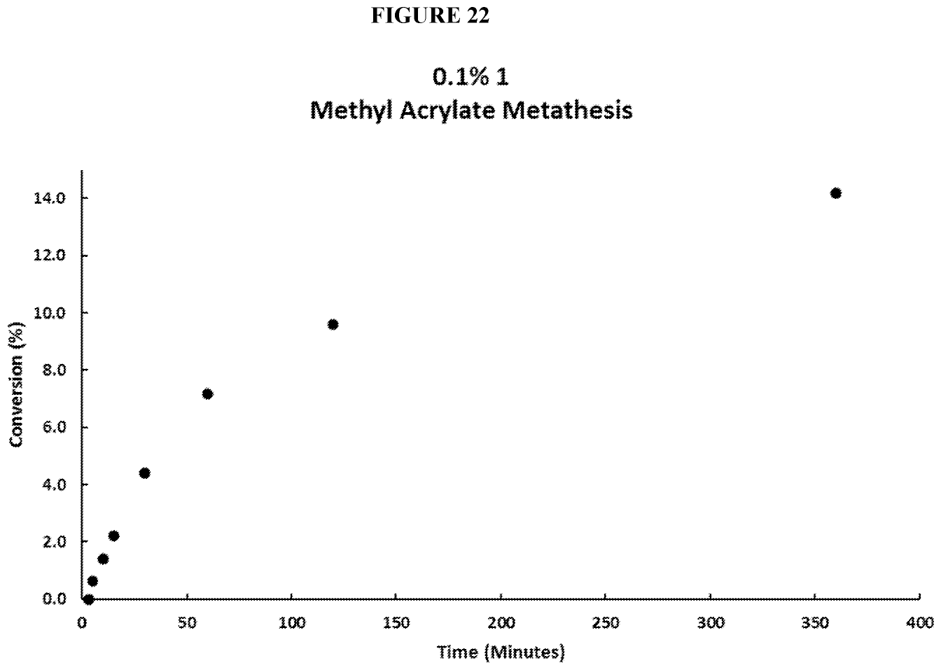

TABLE 9
Conversion of methyl acrylate (also see FIG. 22).

| | % Conversion |
|---|---|
| Min. | M720ASO |
| 3 | * |
| 5 | 0.6 |
| 10 | 1.4 |
| 15 | 2.2 |
| 30 | 4.4 |
| 60 | 7.2 |
| 120 | 9.6 |
| 360 | 14.2 |

Ring-Closing Metathesis (RCM) of Dimethyl 2,2-diallyldimethyl malonate

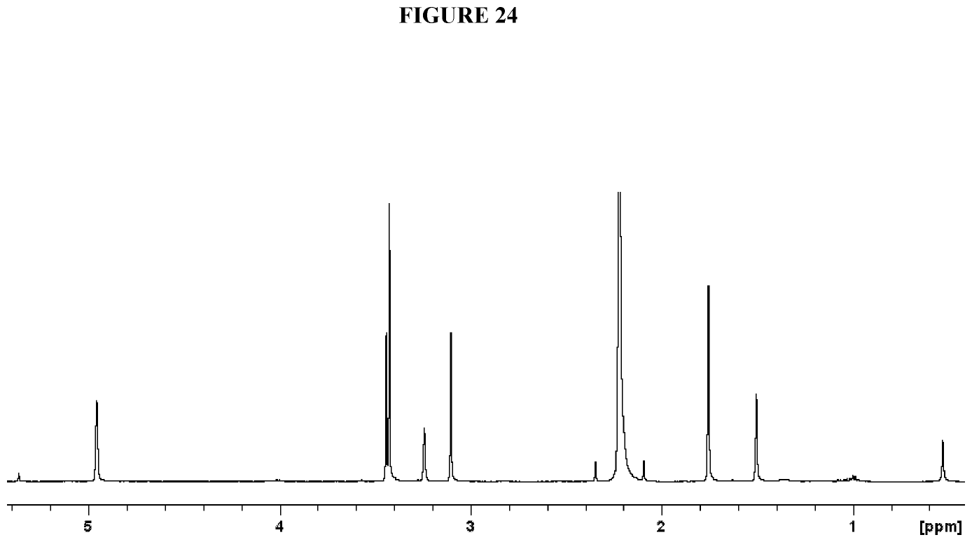

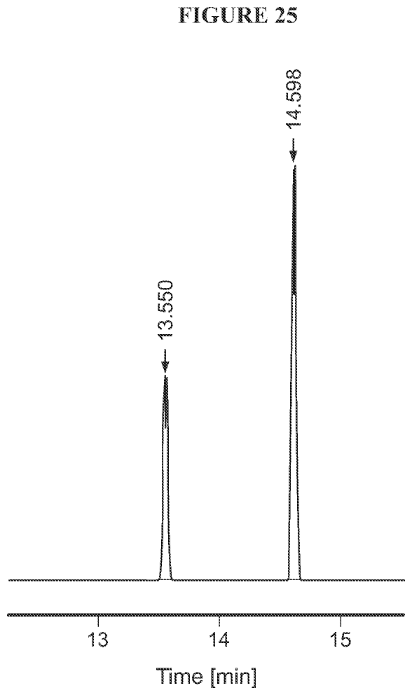

1 (5 mg, 1.1 μmol Ru) was added to a J-Young NMR tube. 0.5 mL of 2.2 M 2,2-diallyldimethyl malonate (dimethyl diallylmalonate) in C₆D₆ is syringed into the NMR tube. The solution contains 1000 equivalents of olefin per Ru. The reaction was monitored by NMR (FIG. 24) periodically over the course of four days (This reaction yields >3× higher if ran under vacuum). FIG. 25 shows GC-FID of RCM reaction with supported catalyst.

TABLE 10
RCM reaction with supported catalyst.

| | M720ASO | GH2 |
|---|---|---|
| Staring | 90.9 | 93.4 |
| material | | |
| Product | 9.1 | 6.6 |

### Cross Metathesis of Allylbenzene and 1,4-diacetoxybutene

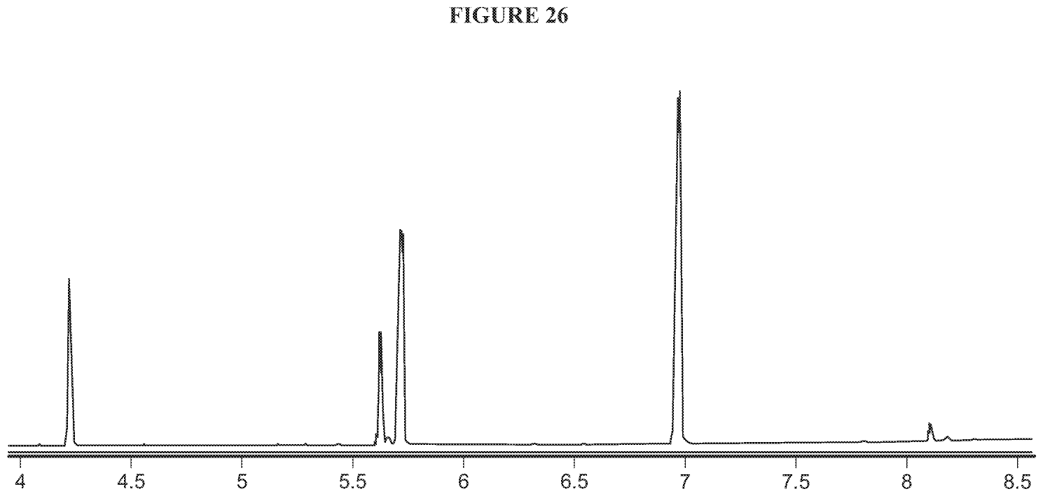

1 (5 mg, 1.1 μmol Ru) was added to a micro reaction vessel, then charged with 0.5 mL of toluene. On a stir plate, 0.5 mL of 2.2M allylbenzene in toluene and 0.5 mL of 4.4M 1,4-diacetoxybutene is syringed into the reaction vessel. The final concentration of each olefin is 0.73M and 1.47M respectively, which contains 1000 and 2000 equivalents of olefin per Ru. The reaction was monitored at regular time points by both GC-FID (FIG. 26) and NMR.

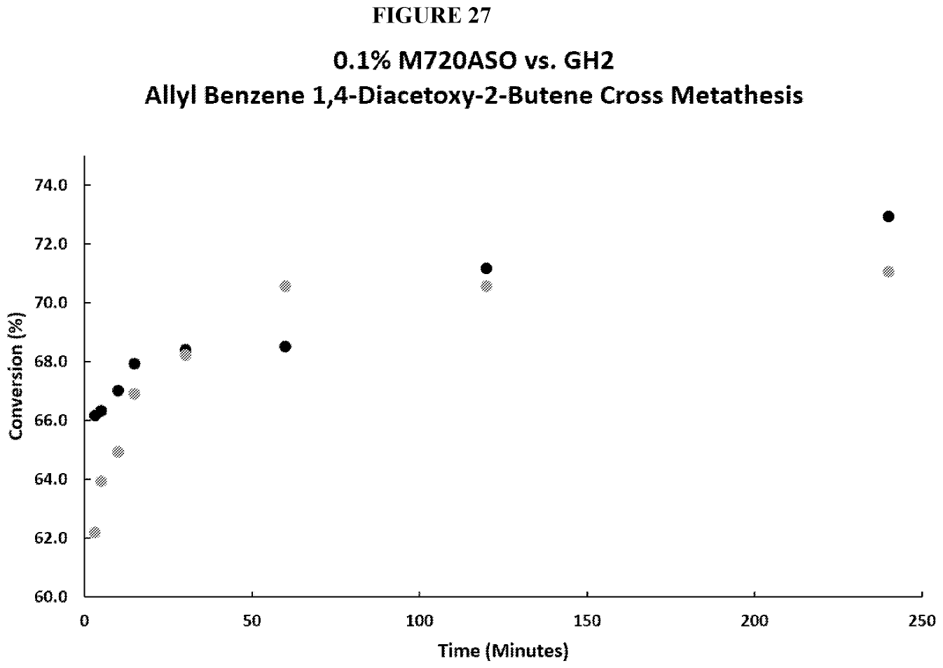

TABLE 11
cross metathesis reaction with the supported
catalyst (also see FIG. 27).

% Conversion CM

| Min. | M720ASO | GH2 |
|---|---|---|
| 3 | 66.2 | 62.2 |
| 5 | 66.3 | 63.9 |
| 10 | 67.0 | 65.0 |
| 15 | 67.9 | 66.9 |
| 30 | 68.4 | 68.2 |
| 60 | 68.5 | 70.6 |
| 120 | 71.2 | 70.6 |
| 240 | 72.9 | 71.1 |

### Ethenolysis of Ethyl Oleate

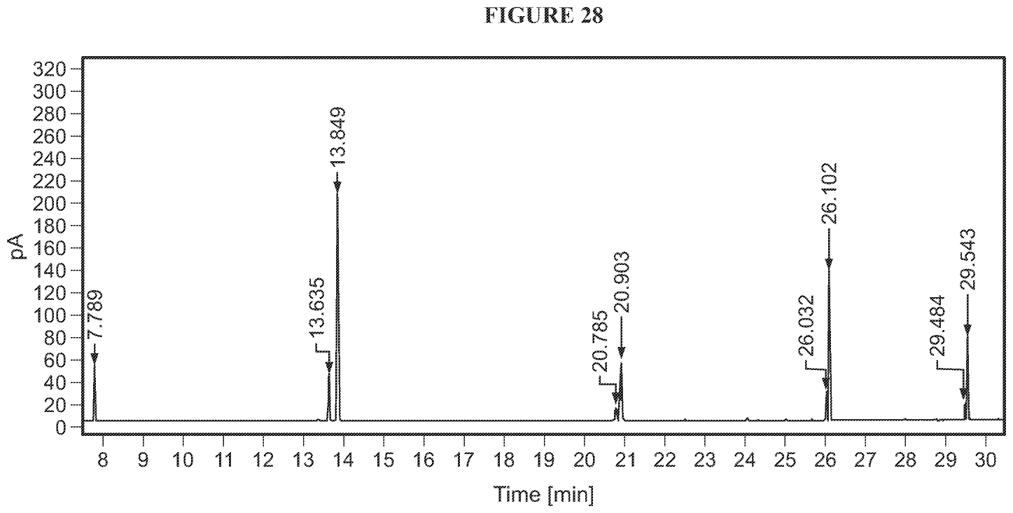

1 (5 mg, 1.1 μmol Ru) and 1 mL of a 1.1M toluene solution of ethyl oleate was added to a 100 mL Teflon-valved flask, then charged with 0.5 mL of toluene. On a Schlenk line, the flask was freeze pump thawed and refilled with an atmosphere of ethylene. The reaction was stirred for 12 hours until the reaction was stopped, upon which (FIG. 28) both GC-MS/FID and NMR samples were prepared.

TABLE 12
Ethenolysis reaction for the supported catalyst.

| | M720AS | GH |
|---|---|---|
| 1 | 14. | 15. |
| 2 | 14. | 14. |
| 3 | 19. | 19. |
| 4 | 35. | 34. |
| 5 | 16. | 16. |

1) 1-decene
2) ethyl dec-9-enoate
3) octadec-9-ene
4) ethyl octadec-9-enoate (ethyl oleate and isomer, mainly the isomer)
5) diethyl octadec-9-enedioate

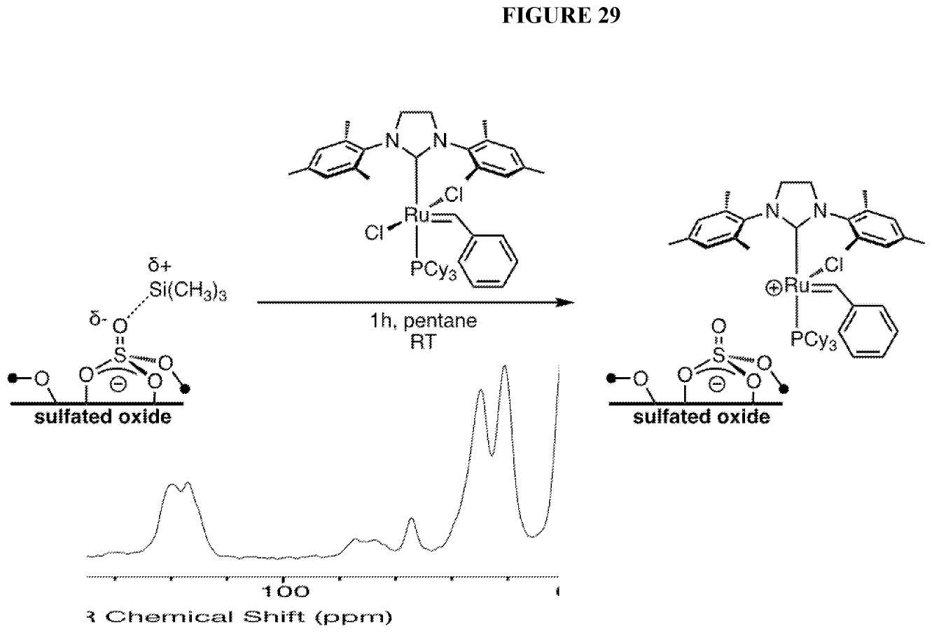

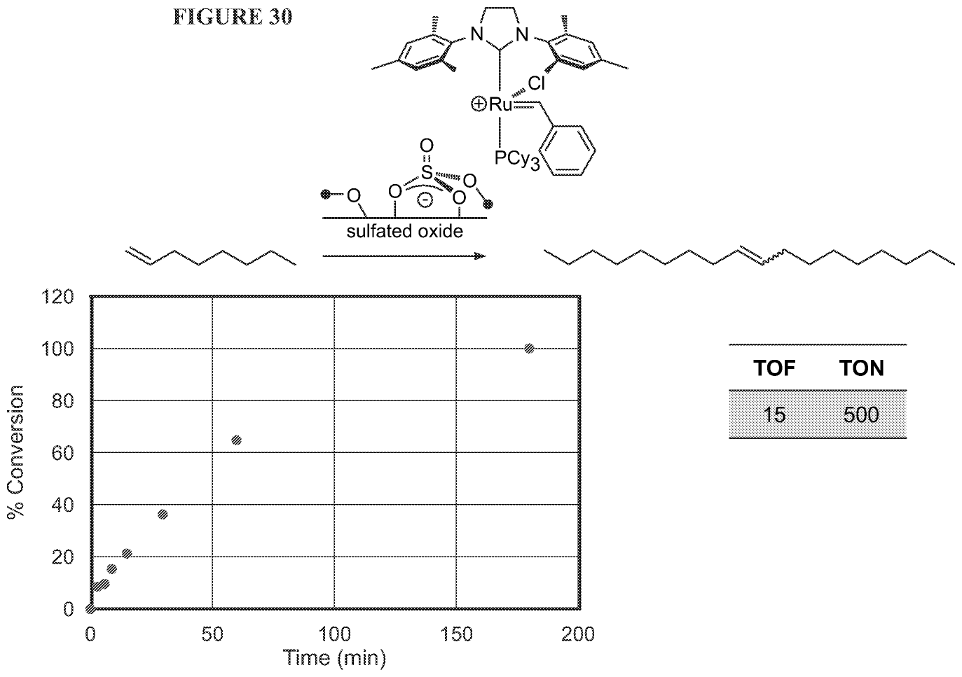

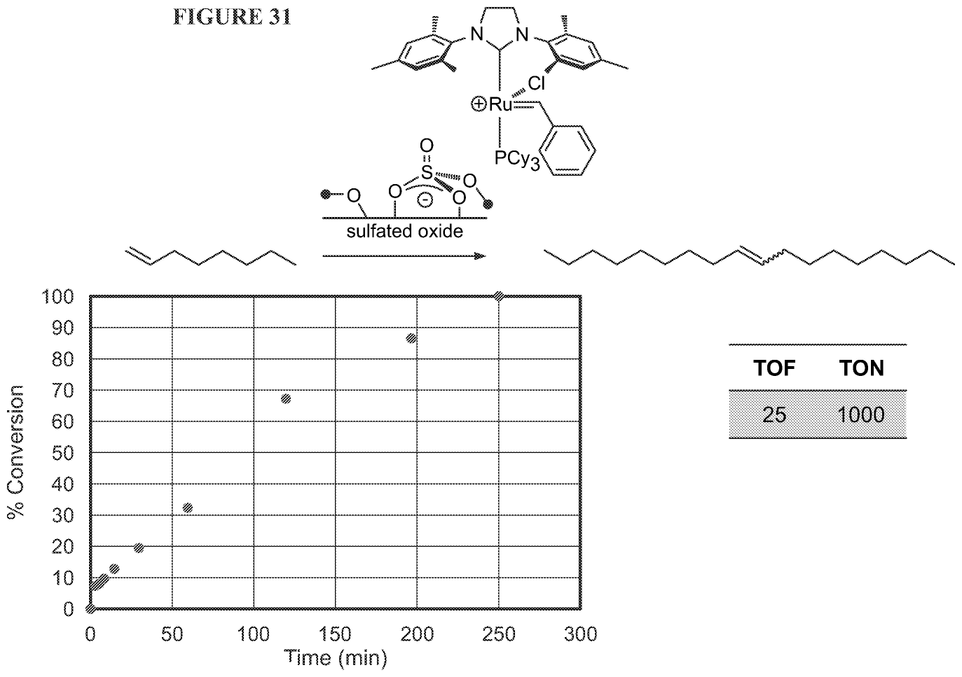

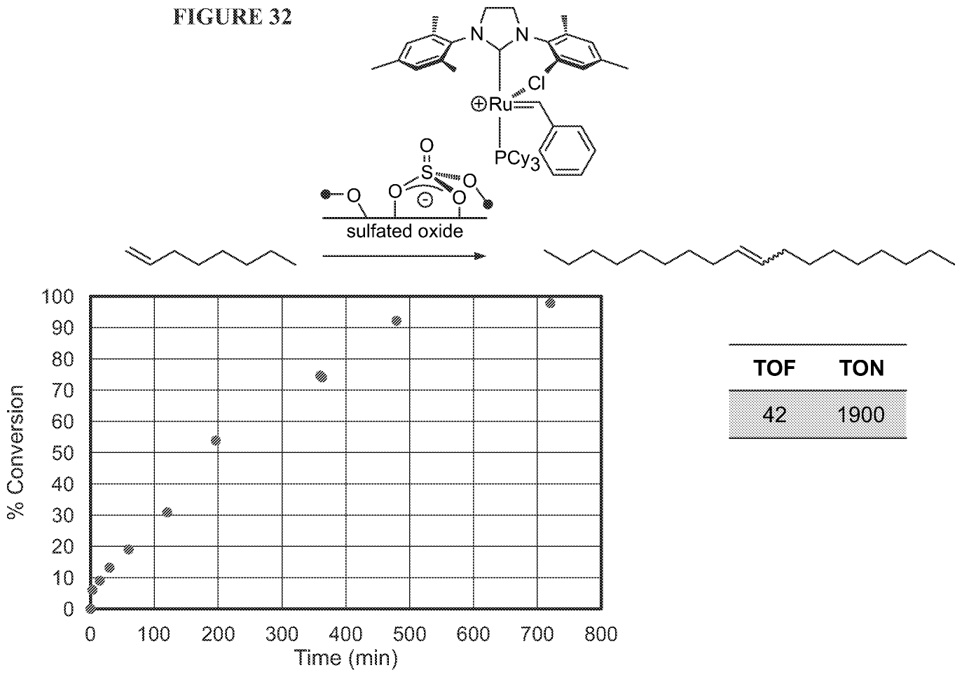

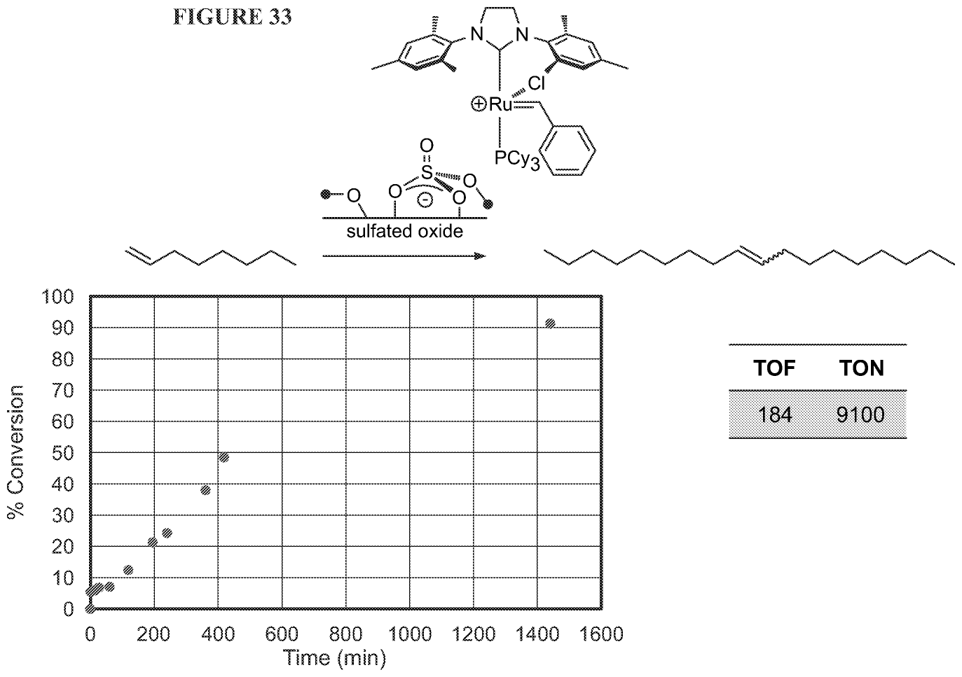

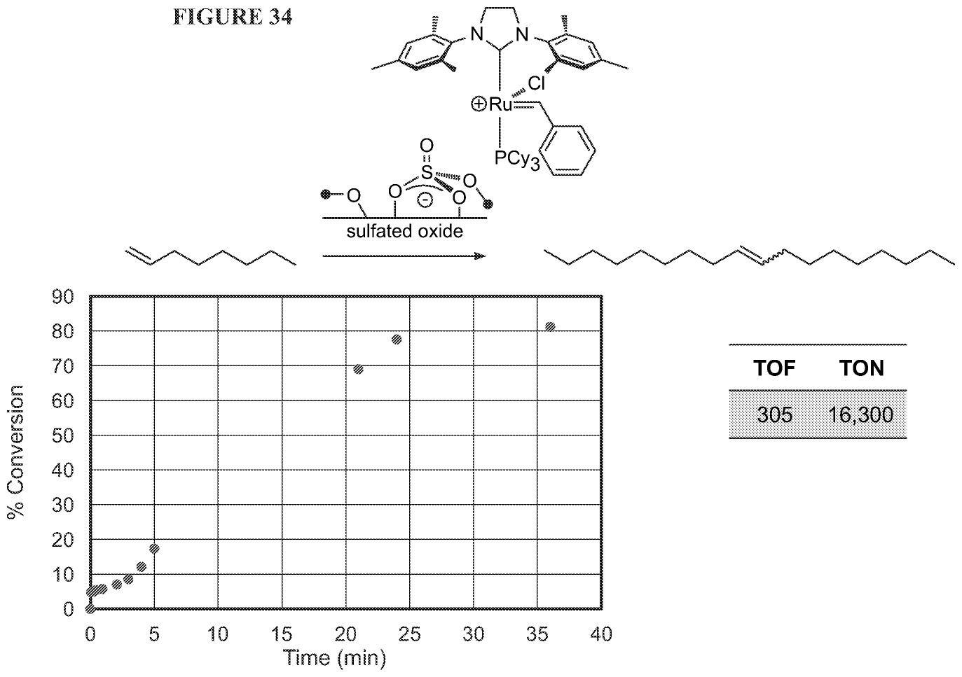

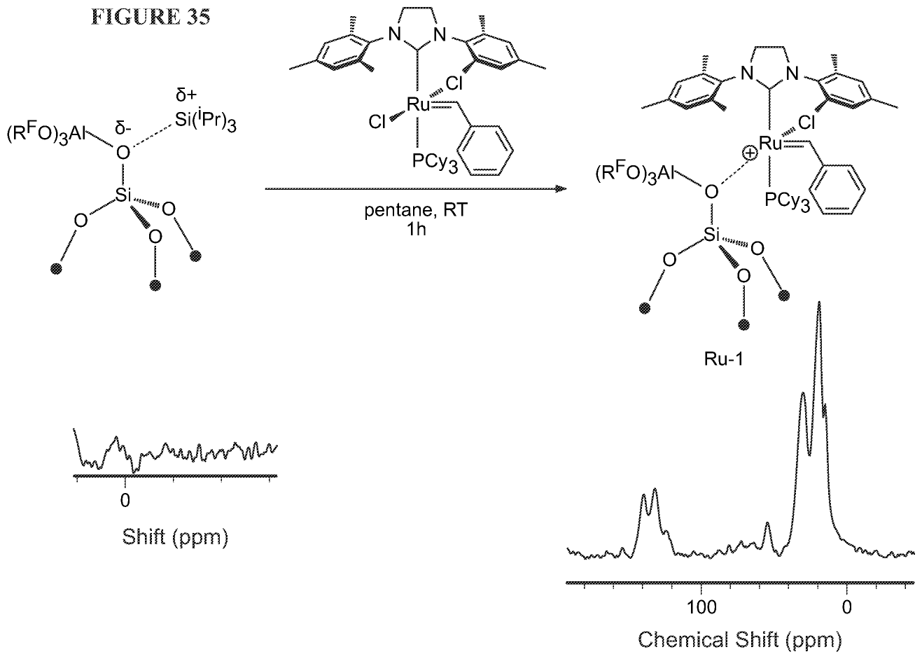

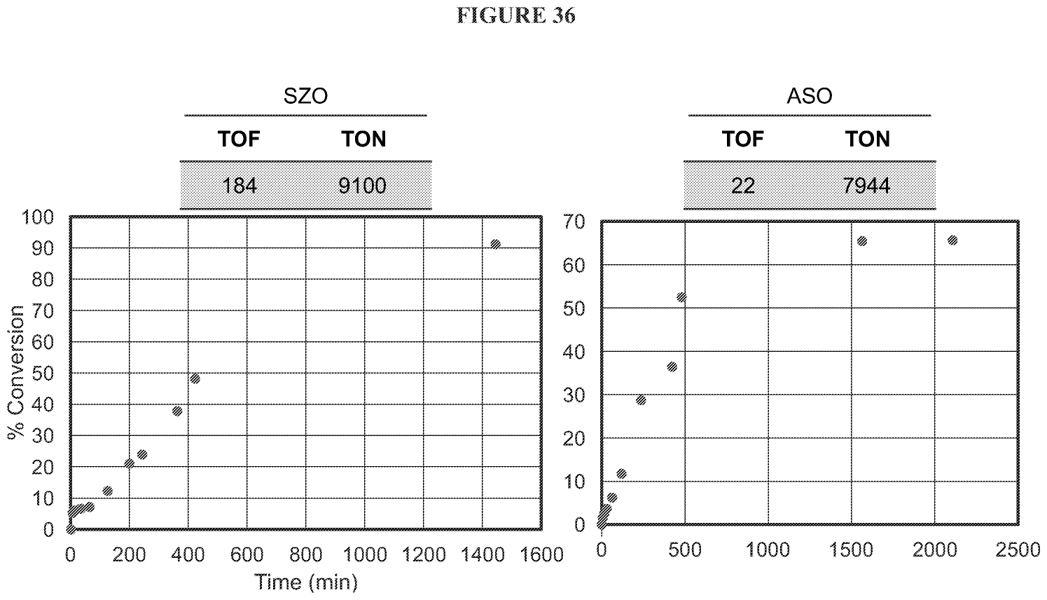

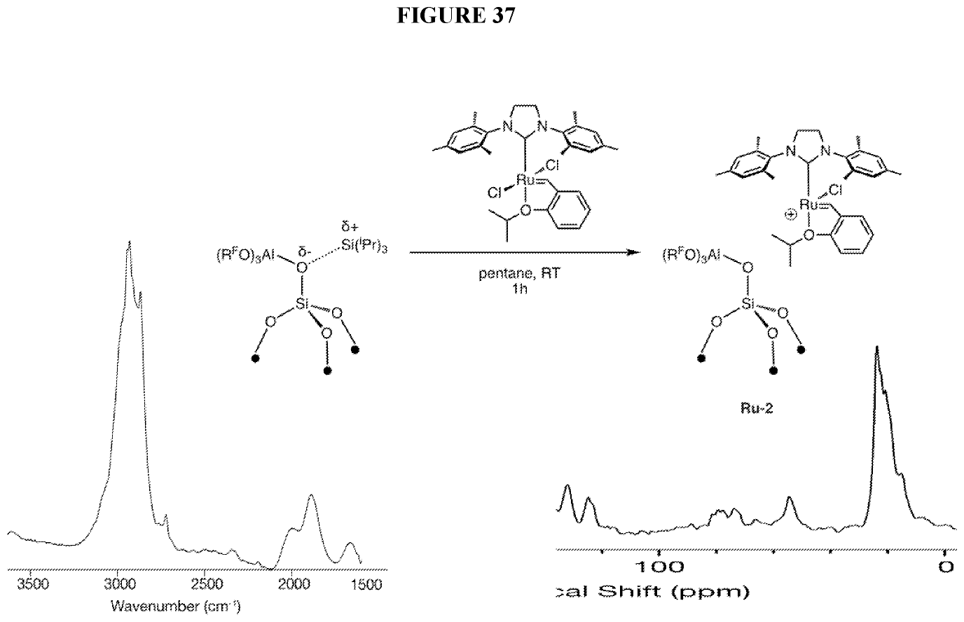

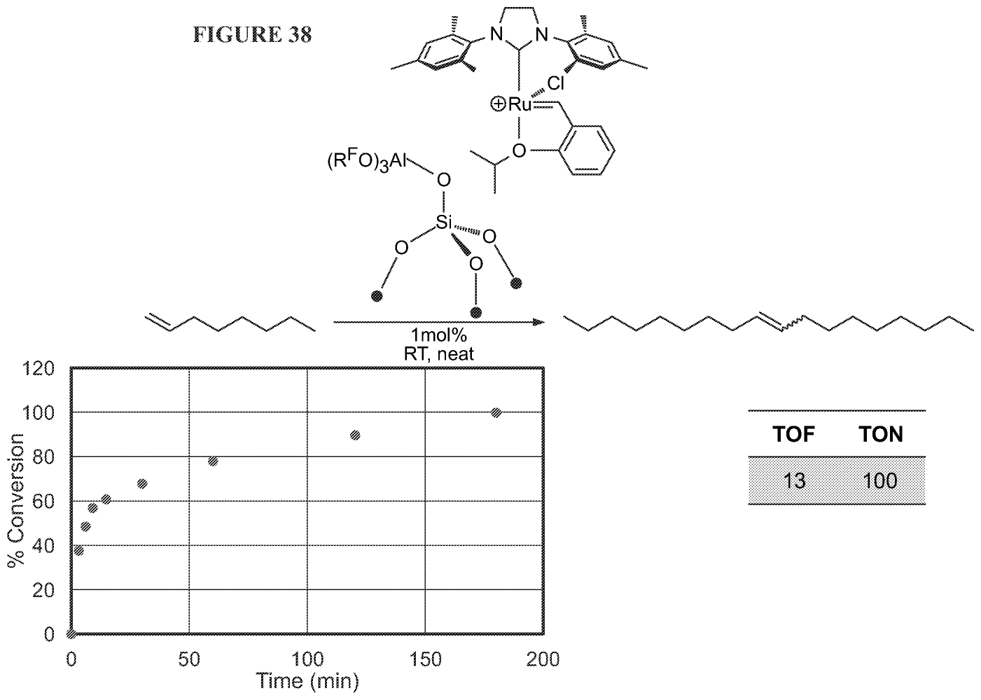

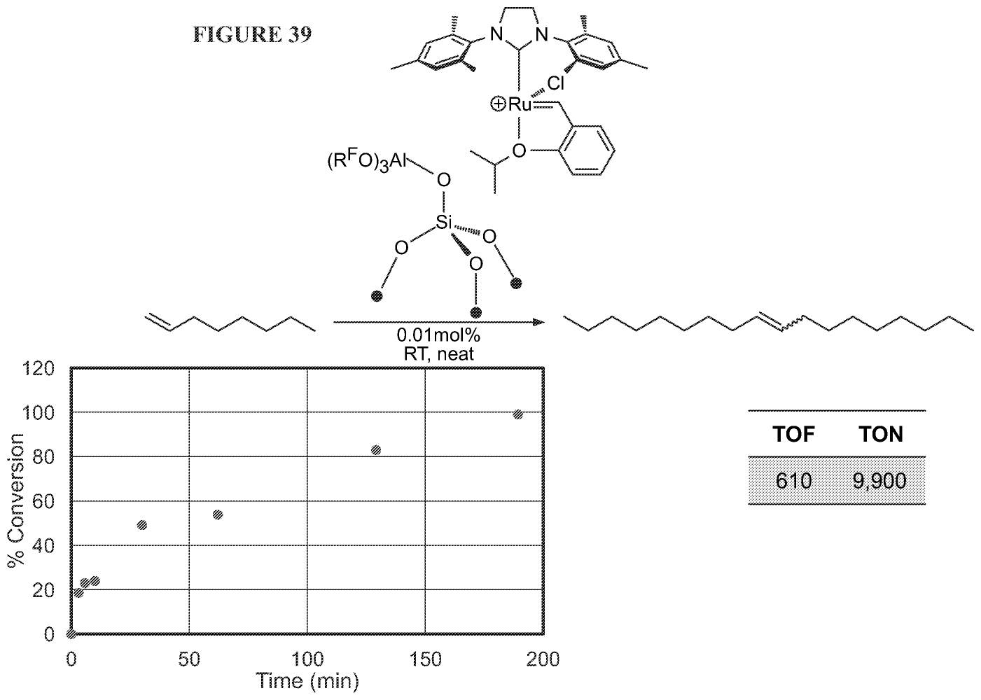

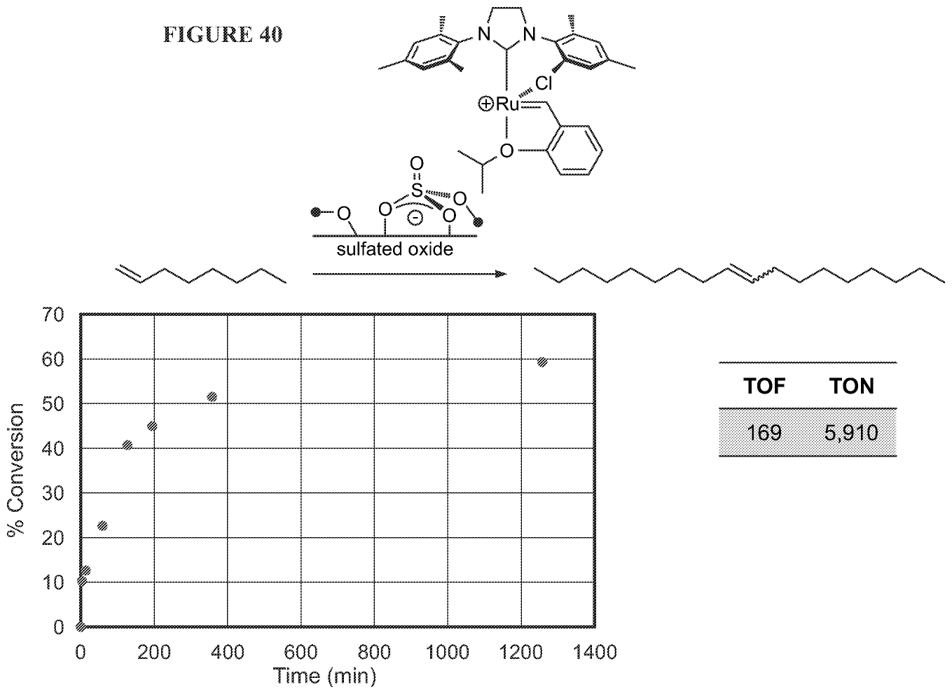

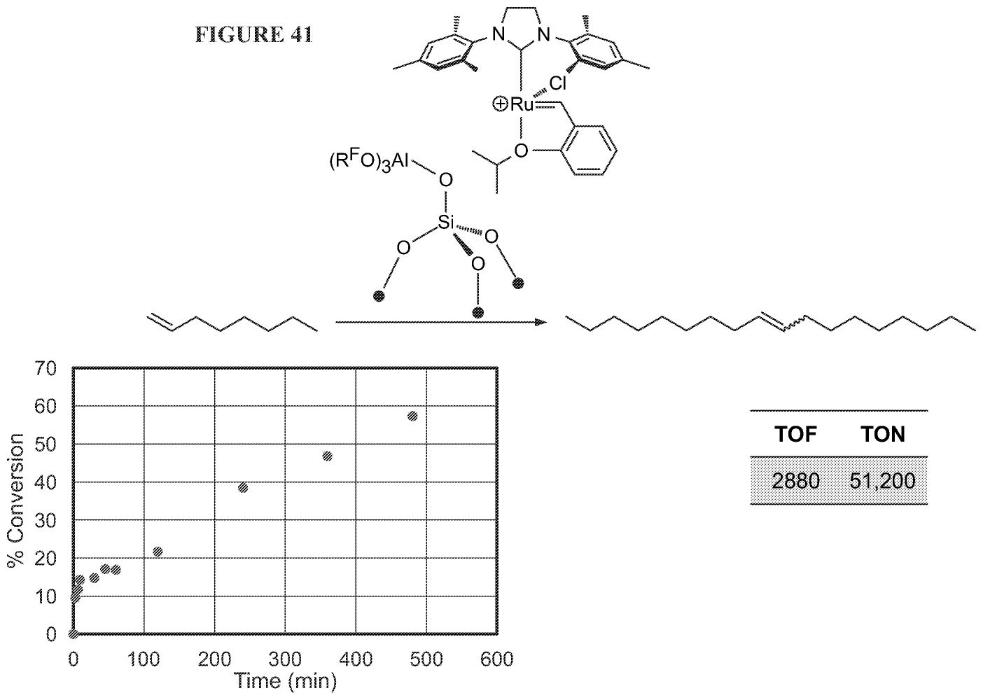

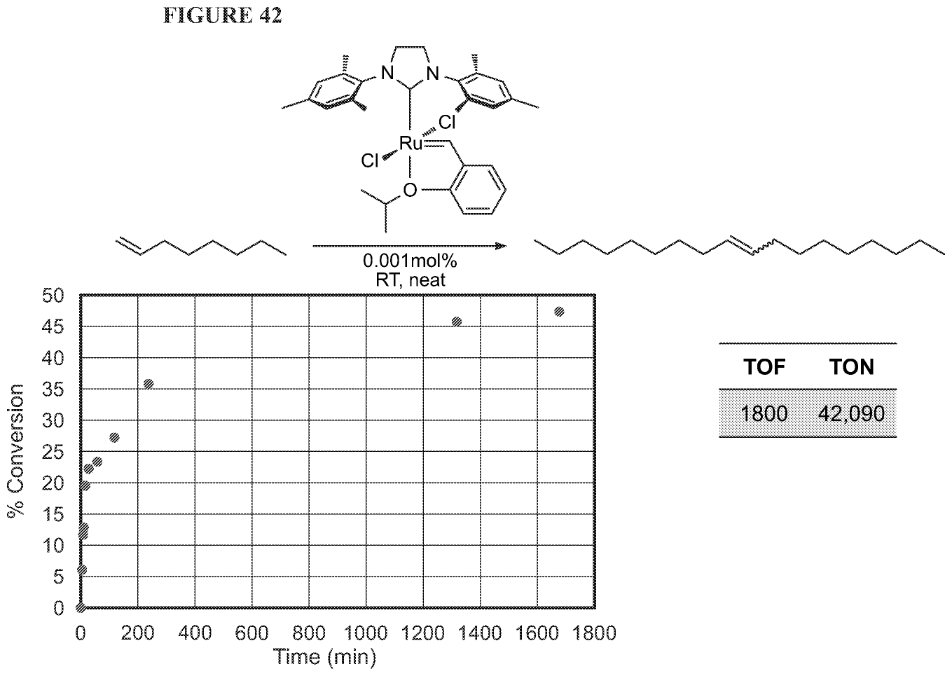

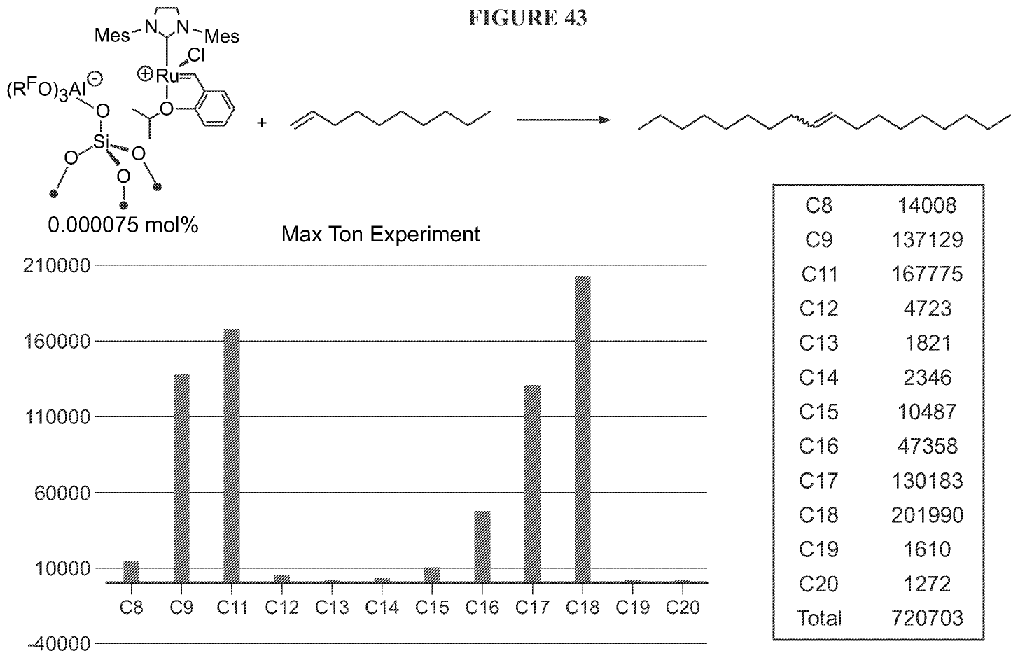

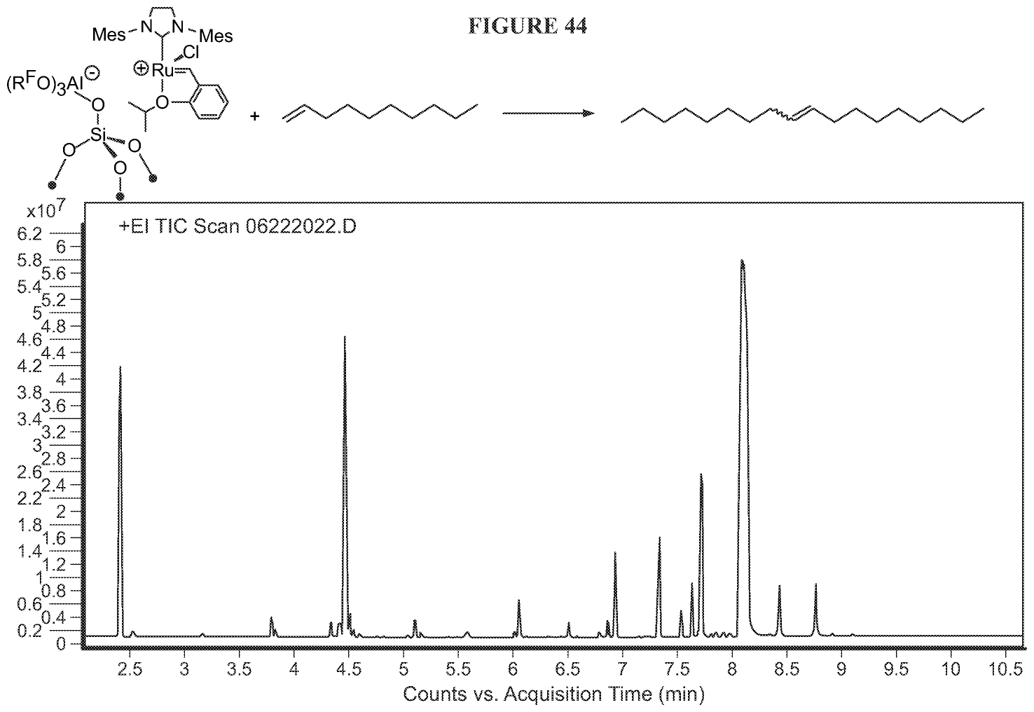

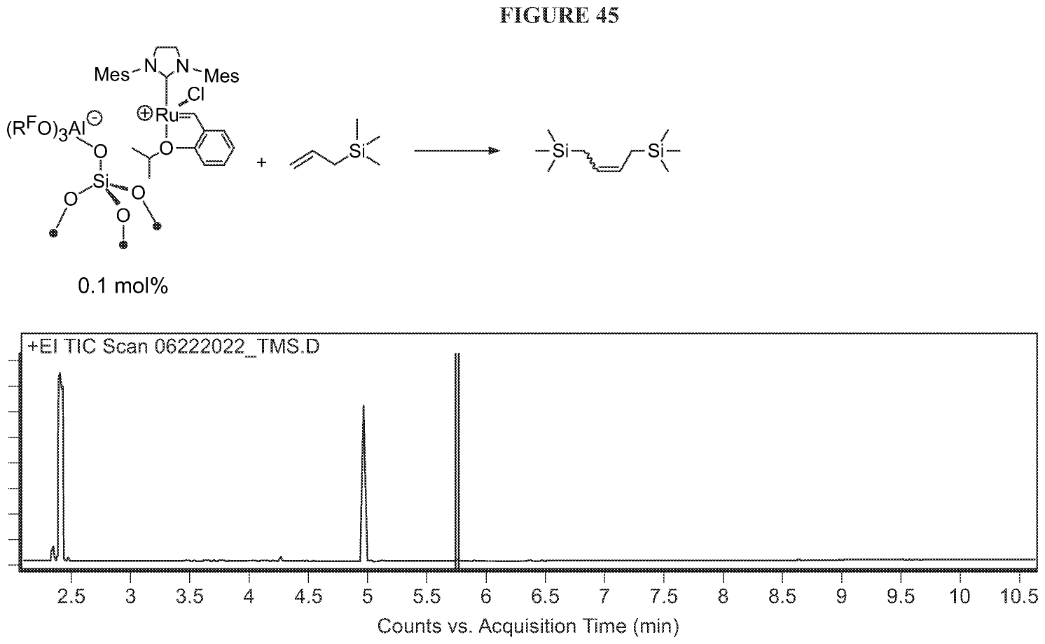

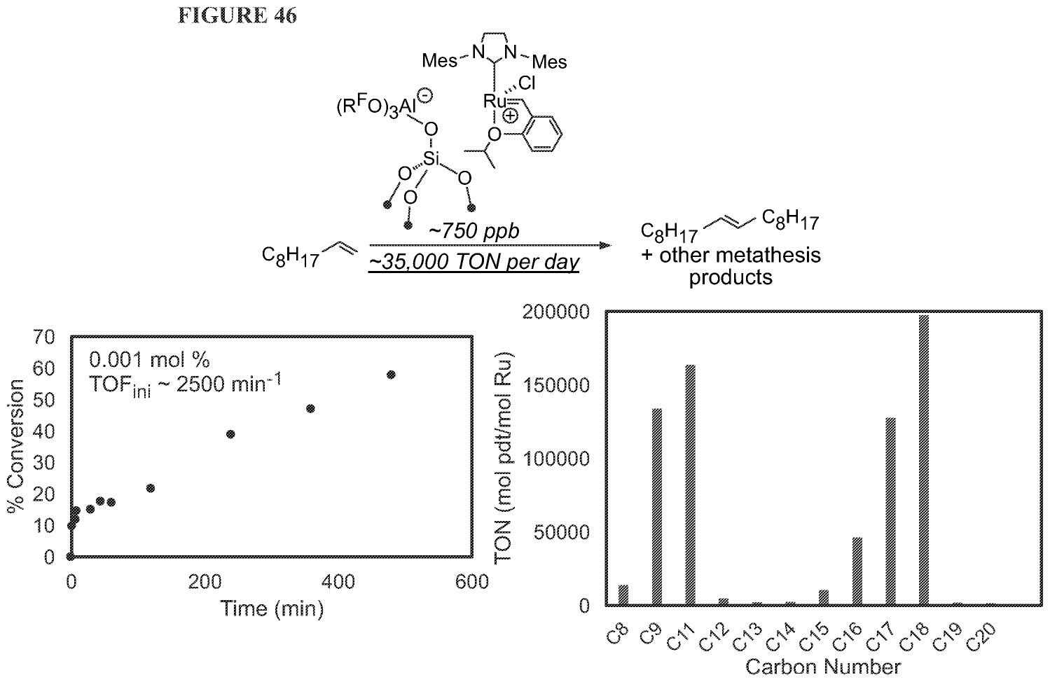

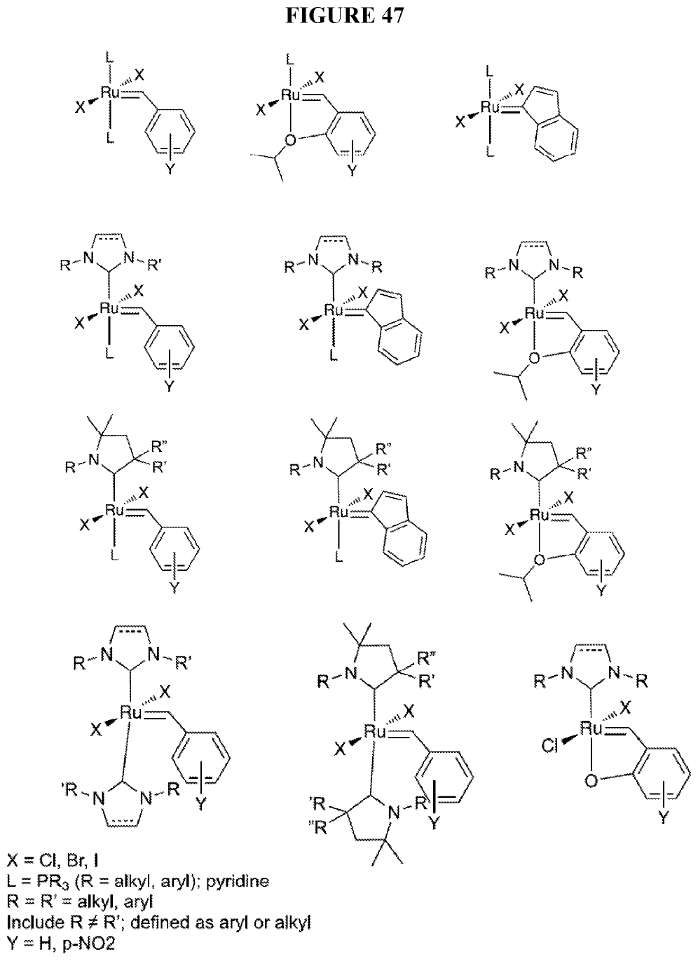

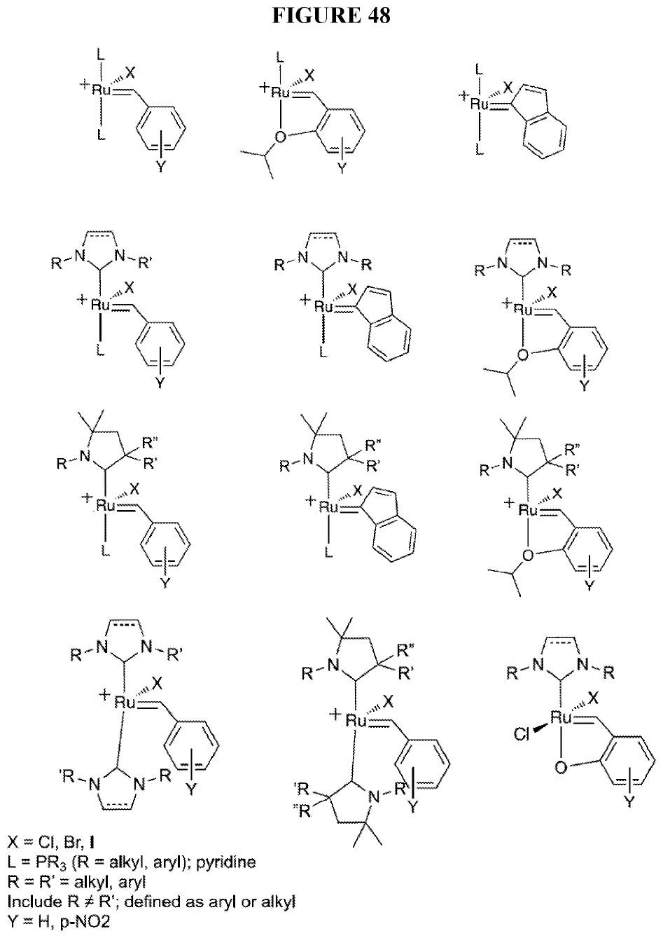

Additional catalysts and/or catalytic tests are also shown in FIGS. 29-46.

### References in Example 1

(1) a. Witzke, R. J.; Chapovetsky, A.; Conley, M. P.; Kaphan, D. M.; Delferro, M. Non-Traditional Catalyst Supports in Surface Organometallic Chemistry. ACS Catal. 2020, 11822-11840; b.Copéret, C.; Allouche, F.; Chan, K. W.; Conley, M. P.; Delley, M. F.; Fedorov, A.; Moroz, I. B.; Mougel, V.; Pucino, M.; Searles, K.; Yamamoto, K.; Zhizhko, P. A. Bridging the Gap between Industrial and Well-Defined Supported Catalysts. Angew. Chem., Int. Ed. 2018, 57, 6398-6440; c.Copéret, C.; Comas-Vives, A.; Conley, M. P.; Estes, D. P.; Fedorov, A.; Mougel, V.; Nagae, H.; Núñez-Zarur, F.; Zhizhko, P. A. Surface Organometallic and Coordination Chemistry toward Single-Site Heterogeneous Catalysts: Strategies, Methods, Structures, and Activities. Chem. Rev. 2016, 116, 323-421; d.Zaera, F. Designing Sites in Heterogeneous Catalysis: Are We Reaching Selectivities Competitive With Those of Homogeneous Catalysts? Chem. Rev. 2022, 122, 8594-8757.
(2) Copéret, C.; Berkson, Z. J.; Chan, K. W.; de Jesus Silva, J.; Gordon, C. P.; Pucino, M.; Zhizhko, P. A. Olefin metathesis: what have we learned about homogeneous and heterogeneous catalysts from surface organometallic chemistry? Chem. Sci. 2021, 12, 3092-3115.
(3) Lwin, S.; Wachs, I. E. Olefin Metathesis by Supported Metal Oxide Catalysts. ACS Catal. 2014, 4, 2505-2520.
(4) a.Schrock, R. R. Multiple Metal-Carbon Bonds for Catalytic Metathesis Reactions (Nobel Lecture). Angew. Chem., Int. Ed. 2006, 45, 3748-3759; b. Schrock, R. R.; Hoveyda, A. H. Molybdenum and Tungsten Imido Alkylidene Complexes as Efficient Olefin-Metathesis Catalysts. Angew. Chem., Int. Ed. 2003, 42, 4592-4633; c.Schrock, R. R. Recent Advances in High Oxidation State Mo and W Imido Alkylidene Chemistry. Chem. Rev. 2009, 109, 3211-3226.
(5) a.Bekyarova, E.; Conley, M. P. The coordination chemistry of oxide and nanocarbon materials. Dalton Trans. 2022, 51, 8557-8570; b. Samudrala, K. K.; Conley, M. P. Effects of surface acidity on the structure of organometallics supported on oxide surfaces. Chem. Commun. 2023, 59, 4115-4127.
(6) Trnka, T. M.; Grubbs, R. H. The Development of L2X2RuCHR Olefin Metathesis Catalysts: An Organometallic Success Story. Acc. Chem. Res. 2001, 34, 18-29.
(7) Conley, M. P.; Copéret, C.; Thieuleux, C. Mesostructured Hybrid Organic, ÄìSilica Materials: Ideal Supports for Well-Defined Heterogeneous Organometallic Catalysts. ACS Catal. 2014, 4, 1458-1469.
(8) a.Culver, D. B.; Conley, M. P. Activation of C—F Bonds by Electrophilic Organosilicon Sites Supported on Sulfated Zirconia. Angew. Chem., Int. Ed. 2018, 57, 14902-14905; b.Culver, D. B.; Venkatesh, A.; Huynh, W.; Rossini, A. J.; Conley, M. P. Al(ORF)3 (RF═C(CF3)3) activated silica: a well-defined weakly coordinating surface anion. Chem. Sci. 2020, 11, 1510-1517.
(9) a.Reed, C. A. The Silylium Ion Problem, R3Si+. Bridging Organic and Inorganic Chemistry. Acc. Chem. Res. 1998, 31, 325-332; b.Klare, H. F. T.; Albers, L.; Süsse, L.; Keess, S.; Müller, T.; Oestreich, M. Silylium Ions: From Elusive Reactive Intermediates to Potent Catalysts. Chem. Rev. 2021, 121, 5889-5985.
(10) a.Douvris, C.; Reed, C. A. Increasing the Reactivity of Vaska's Compound. Oxidative Addition of Chlorobenzene at Ambient Temperature. Organometallics 2008, 27, 807-810; b.Guo, F.-S.; Chen, Y.-C.; Tong, M.-L.; Mansikkamäki, A.; Layfield, R. A. Uranocenium: Synthesis, Structure, and Chemical Bonding. Angew. Chem., Int. Ed. 2019, 58, 10163-10167; c. Guo, F.-S.; Day, B. M.; Chen, Y.-C.; Tong, M.-L.; Mansikkamäki, A.; Layfield, R. A. Magnetic hysteresis up to 80 kelvin in a dysprosium metallocene single-molecule magnet. Science 2018, 362, 1400-1403; d. Goodwin, C. A. P.; Reta, D.; Ortu, F.; Chilton, N. F.; Mills, D. P. Synthesis and Electronic Structures of Heavy Lanthanide Metallocenium Cations. J. Am. Chem. Soc. 2017, 139, 18714-18724; e. Nicholas, H. M.; Vonci, M.; Goodwin, C. A. P.; Loo, S. W.; Murphy, S. R.; Cassim, D.; Winpenny, R. E. P.; McInnes, E. J. L.; Chilton, N. F.; Mills, D. P. Electronic structures of bent lanthanide (III) complexes with two N-donor ligands. Chem. Sci. 2019, 10, 10493-10502; f.Goodwin, C. A. P.; Ortu, F.; Reta, D.; Chilton, N. F.; Mills, D. P. Molecular magnetic hysteresis at 60 kelvin in dysprosocenium. Nature 2017, 548, 439-442; g.Guo, F.-S.; Day, B. M.; Chen, Y.-C.; Tong, M.-L.; Mansikkamäki, A.; Layfield, R. A. A Dysprosium Metallocene Single-Molecule Magnet Functioning at the Axial Limit. Angew. Chem., Int. Ed. 2017, 56, 11445-11449; h. Varga, V.; Lamač, M.; Horáček, M.; Gyepes, R.; Pinkas, J. Hydrosilane-B(C6F5)3 adducts as activators in zirconocene catalyzed ethylene polymerization. Dalton Trans. 2016, 45, 10146-10150.
(11) a.Gao, J.; Dorn, R. W.; Laurent, G. P.; Perras, F. A.; Rossini, A. J.; Conley, M. P. A Heterogeneous Palladium Catalyst for the Polymerization of Olefins Prepared by Halide Abstraction Using Surface R3Si+ Species. Angew. Chem., Int. Ed. 2022, n/a, e202117279; b. Rodriguez, J.; Conley, M. P. A Heterogeneous Iridium Catalyst for the Hydroboration of Pyridines. Org. Lett. 2022, 24, 4680-4683.
(12) Garber, S. B.; Kingsbury, J. S.; Gray, B. L.; Hoveyda, A. H. Efficient and Recyclable Monomeric and Dendritic Ru-Based Metathesis Catalysts. J. Am. Chem. Soc. 2000, 122, 8168-8179.
(13) Si, G.; Tan, C.; Chen, M.; Chen, C. A Cocatalyst Strategy to Enhance Ruthenium-Mediated Metathesis Reactivity towards Electron-Deficient Substrates. Angew. Chem., Int. Ed. 2022, n/a, e202203796.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A catalyst composition comprising a cationic Ruthenium (Ru) catalyst having structure of Formula I: 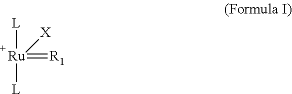
wherein
X is absent, halogen, O(O═)CRₜ or —ORₓ, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is O(O═)CRₜ, the one (the non-carbonyl oxygen) or two oxygen(s) of O(O═)CRₜ is bonded with the Ru;
R₁ is aryl (e.g., indenylidene) or (CH)-aryl (e.g., benzylidene), wherein the aryl or (CH)-aryl is optionally substituted with one or more substituent selected from the group consisting of hydroxy, halogen, alkyl, alkoxy, nitro (—NO₂), or aryl; and
each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl (e.g., mesityl), and wherein Rₐ is alkyl, cycloalkyl, or aryl that is optionally substituted with one or more alkyl; wherein one L is absent when X is O(O═)CRₜ and the two oxygen(s) of O(O═)CRₜ are bonded with the Ru;
wherein when X is absent, one L (a bidentate ligand when X is absent) is heterocycle, or heteroaryl substituted with one or more substituent (e.g., alkyl or adamantyl) and the substituent forms a Ru—C bond with the Ru;
wherein Ru, together with the intervening carbon atoms of R₁, and the oxygen atom of —O— or alkoxy of one L, optionally form a ring (e.g., a five-membered ring);
and a support.

2. The catalyst composition of claim 1, wherein the cationic Ru catalyst has structure of Formula Ia:

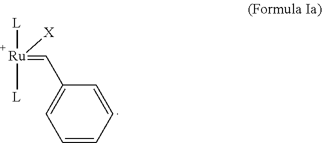

3. The catalyst composition of claim 1, wherein the cationic Ru catalyst has structure of Formula Ib: 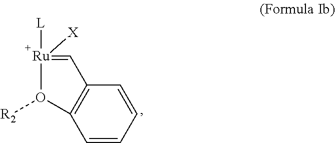
wherein R₂ is alkyl (e.g., C1-C6 alkyl).

4. The catalyst composition of claim 1, wherein the cationic Ru catalyst has structure of Formula Ic:

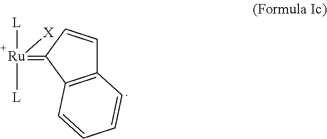

5. The catalyst composition of any one of claims 1-4, wherein each L is independently —O—, alkoxy, P(Rₐ)₃, or heterocycle.

6. The catalyst composition of any one of claims 1-5, wherein each L is independently selected from the group consisting of —O—, alkoxy, P(Rₐ)₃, 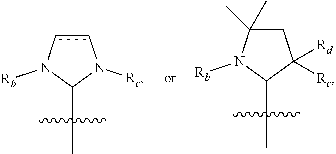
wherein R_{b}, R_{c}, R_{d} is independently H, alkyl, adamantyl or aryl; and the aryl is optionally substituted with one or more alkyl.

7. The catalyst composition of claim 6, wherein each L is independently selected from the group consisting of —O—, alkoxy, P(Rₐ)₃,
or

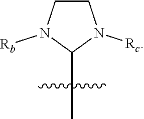

8. The catalyst composition of any one of claims 3 and 5-7, wherein the cationic Ru catalyst has structure of Formula Id or Formula Ie: 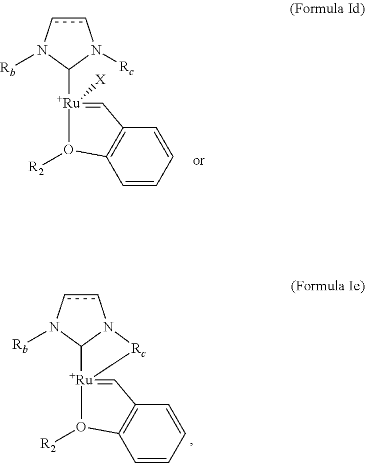
wherein R₂ is alkyl (e.g., C1-C6 alkyl).

9. The catalyst composition of claim 8, wherein R₂ is isopropyl.

10. The catalyst composition of any one of claims 6-9, wherein R_{b} and R_{c} are each independently phenyl optionally substituted with one or more alkyl.

11. The catalyst composition of claim 10, wherein R_{b} and R_{c} are each mesityl (Mes).

12. The catalyst composition of any one of claims 1-11, wherein X is halogen (e.g., Cl, Br, or I), or —ORₓ.

13. The catalyst composition of any one of claims 1-11, wherein X is O(O═)CRₜ or —ORₓ.

14. The catalyst composition of any one of claims 1, 5-7 and 9-13, wherein the cationic Ru catalyst has structure of 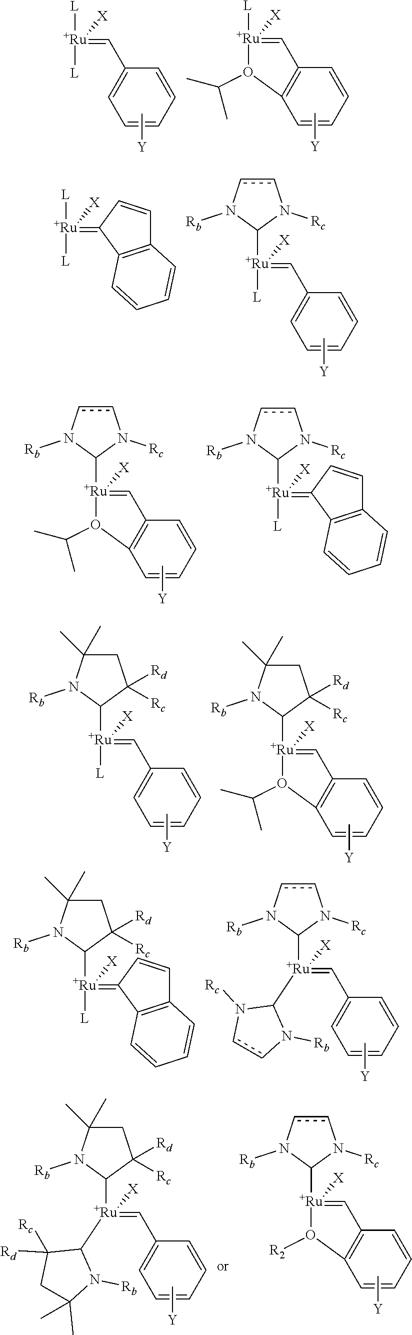
wherein substituent Y is selected from the group consisting of hydroxy, halogen, alkyl, alkoxy, nitro (—NO₂), or aryl.

15. The catalyst composition of claim 3, wherein the cationic Ru catalyst has structure of

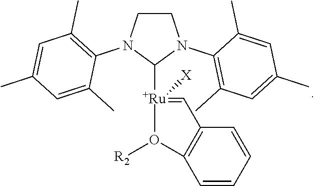

16. The catalyst composition of claim 1, wherein the cationic Ru catalyst has structure of

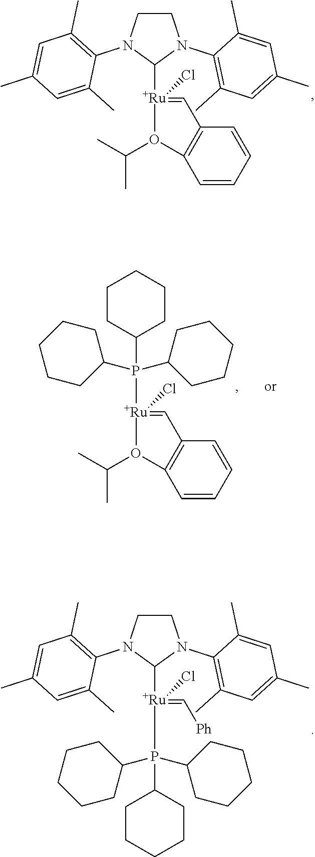

17. The catalyst composition of claim 1, wherein the cationic Ru catalyst has structure of

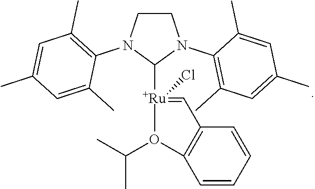

18. The catalyst composition of any one of claims 1-17, wherein the support comprises sulfated metal oxide.

19. The catalyst composition of any one of claims 1-17, wherein the support comprises oxide-Aluminum alkoxide (EₓO_{y}/Al(OR^{s})₃) having structure of 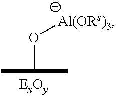
wherein E is metal or non-metal; x is 1 or 2; and y is 2 or 3, and wherein R^{s} is alkyl (e.g., C1-C6 or C1-C4 alkyl such as t-butyl) optionally substituted with one or more halogen (e.g., F).

20. The catalyst composition of any one of claim 1-17 or 19, wherein the support comprises silica-aluminum alkoxide SiO₂/Al(OR^{s})₃, wherein R^{s} is alkyl optionally substituted with one or more halogen (e.g., F).

21. The catalyst composition of claim 19 or 20, wherein R^{s} is perfluoro alkyl (e.g., C(CF₃)₃).

22. The catalyst composition of claim 21, wherein the silica-aluminum alkoxide (SiO₂/Al(OR^{s})₃) has structure of

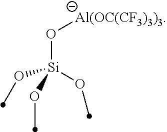

23. The catalyst composition of any one of claims 18-22, wherein the catalyst composition comprises ion-pair having structure of

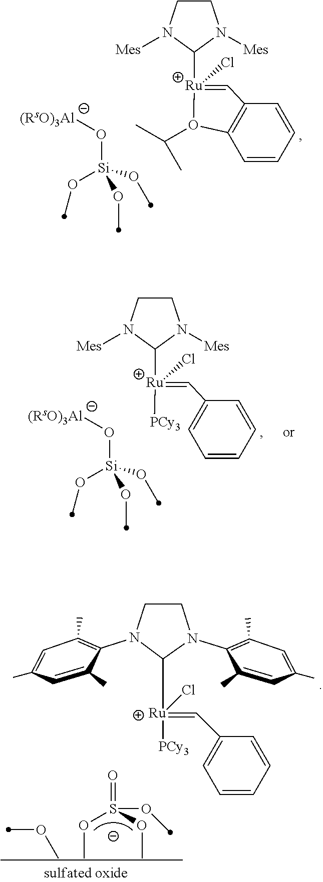

24. A method for catalyzing olefin metathesis, comprising contacting one or more reactant olefin with a catalyst composition according to any one of claims 1-23.

25. The method of claim 24, wherein two identical reactant olefins are coupled to form a product olefin.

26. The method of claim 24, wherein two different reactant olefins are contacted with the catalyst composition.

27. The method of claim 24, wherein the olefin metathesis is cross-metathesis, ring-closing metathesis, or ring-opening metathesis.

28. The method of claim 24, wherein the olefin metathesis is cross-metathesis.

29. The method of claim 24, wherein the olefin metathesis is ethenolysis reaction.

30. A method of making a catalyst composition according to any one of claims 1-23, comprising contacting a Ru compound of Formula II with a silylium on a support,
wherein the silylium has structure of ⁺Si(Rₘ)₃, wherein Rₘ is alkyl or aryl, and the aryl is optionally substituted with one or more alkyl; and
the Ru compound of Formula II is 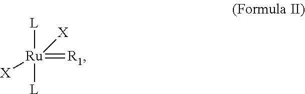
each X is independently halogen, O(O═)CRₜ or —ORₓ, one X may be absent, wherein Rₜ is alkyl or aryl and the alkyl, or aryl is optionally substituted with one or more substituent of hydroxy or halogen (e.g., F); wherein Rₓ is alkyl, alkanoyl, or aryl, and the alkyl, alkanoyl, or aryl is optionally substituted with one or more substituent of hydroxy or halogen (e.g., F); wherein when X is —O(O═)CRₜ, the one oxygen of —O(O═)CRₜ is bonded with the Ru, or only one X is O(O═)CRₜ wherein the two oxygens of O(O═)CRₜ are bonded with the Ru;
R₁ is aryl (e.g., indenylidene) or (CH)-aryl (e.g., benzylidene), wherein the aryl or (CH)-aryl is optionally substituted with one or more substituent selected from the group consisting of hydroxy, halogen, alkyl, alkoxy, nitro (—NO₂), or aryl; and
each L is independently —O—, alkoxy, P(Rₐ)₃, heterocycle, or heteroaryl, one L may be absent, wherein the heterocycle, or heteroaryl is optionally substituted with one or more substituent selected from the group consisting of hydroxy, halogen, alkyl, adamantyl, alkoxy, nitro (—NO₂), or aryl that is optionally substituted with one or more alkyl (e.g., mesityl), and wherein Rₐ is alkyl, cycloalkyl, or aryl that is optionally substituted with one or more alkyl; wherein one L is absent when only one X is O(O═)CRₜ and the two oxygen(s) of O(O═)CRₜ are bonded with the Ru;
wherein when one X is absent, one L (a bidentate ligand when X is absent) is heterocycle, or heteroaryl substituted with one or more substituent (e.g., alkyl or adamantyl) and the substituent forms a Ru—C bond with the Ru;
wherein Ru, together with the intervening carbon atoms of R₁, and the oxygen atom of —O— or alkoxy of one L, optionally form a ring (e.g., a five-membered ring).

31. The method of claim 30, wherein Rₘ is isopropyl.

32. The method of claim 30 or 31, wherein the support is acoording to any one of claims 18-22.

33. The method of claim 30, 31 or 32, wherein the silynium on a support has structure of 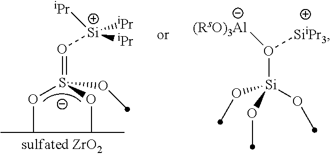
wherein R^{s} is alkyl optionally substituted with one or more halogen.

34. The method of any one of claim 30-33, wherein Ru compound has structure of formula IIa,

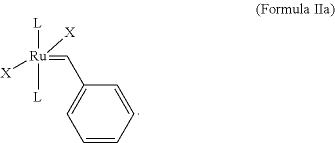

35. The method of any one of claim 30-33, wherein Ru compound has structure of formula IIb, 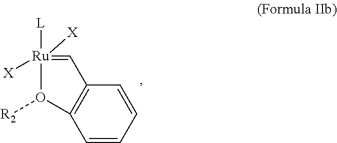
wherein R₂ is alkyl (e.g., isopropyl).

36. The method of any one of claim 30-33, wherein Ru compound has structure of formula IIc,

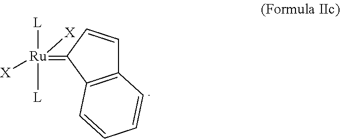

37. The method of any one of claim 30-33, wherein Ru compound has structure of formula IId or IIe, 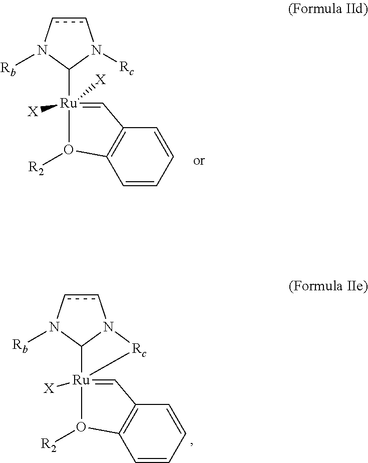
wherein R₂ is alkyl (e.g., isopropyl).

38. The method of any one of claim 30-33, wherein Ru compound has structure of

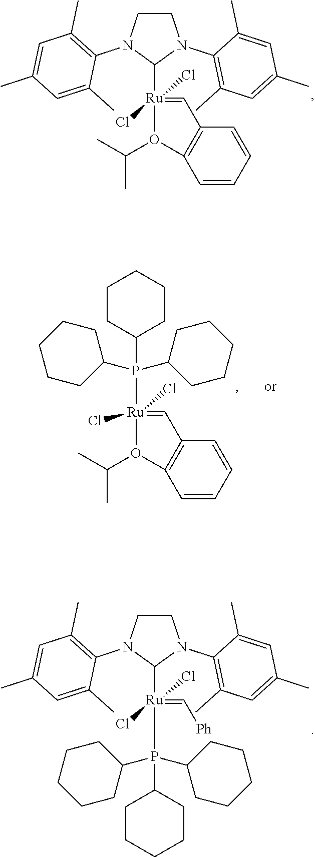

39. The method of any one of claim 30-33, wherein Ru compound has structure of [chemical structure]
